(19) United States
(12) Patent Application Publication
(10) Pub. No.: US 2026/0150101 A1
(43) Pub. Date: May 28, 2026

(54) TERMINAL APPARATUS, METHOD OF TERMINAL APPARATUS AND BASE STATION APPARATUS

(71) Applicant: DENSO CORPORATION, Kariya-city (JP)

(72) Inventor: Tatsuki NAGANO, Kariya-city (JP)

(21) Appl. No.: 19/454,000

(22) Filed: Jan. 20, 2026

Related U.S. Application Data
(63) Continuation of application No. PCT/JP2024/018456, filed on May 20, 2024.

(30) Foreign Application Priority Data
Jul. 26, 2023 (JP) 2023-121582

(51) Int. Cl. H04W 72/1268

(52) U.S. Cl. CPC H04W 72/1268

(57) ABSTRACT

Provided is a terminal apparatus configured to receive, from a base station apparatus, a radio resource control (RRC) message including information for configuring an identifier (ID) of a logical channel group (LCG) to which a logical channel (LCH) belongs, and trigger a delay status report in a case where a shortest remaining time of a discard timer for data becomes below a threshold for the LCG.

### CROSS-REFERENCE TO RELATED APPLICATION

This application is a continuation application of International Patent Application No. PCT/JP2024/018456, filed May 20, 2024, which designated the U.S. and claims the benefit of priority to Japanese Patent Application No. 2023-121582, filed on Jul. 26, 2023. The entire disclosures of the above applications are incorporated herein by reference.

### TECHNICAL FIELD

The present disclosure relates to a terminal apparatus, a method of a terminal apparatus, and a base station apparatus.

### BACKGROUND

In recent years, a technology of extended reality (XR) has been developed. XR is a concept including multi-media integration technologies, such as virtual reality (VR), augmented reality (AR), mixed reality (MR), and substitutional reality (SR). In XR, three-dimensional time series image data in a real space and/or a virtual space, audio data of a plurality of channels (stereo, 5.1ch or the like), other data presented to a user, control data, and the like are transmitted and received in parallel. XR requires low latency and high reliability in order to maintain and enhance quality of experience of users.

Implementation of XR in Fifth Generation New Radio (5G NR) being radio specifications defined by the Third Generation Partnership Project (3GPP (trademark)) is studied.

### SUMMARY

In one or more embodiments, a terminal apparatus is configured to receive, from a base station apparatus, a radio resource control (RRC) message including information for configuring an identifier (ID) of a logical channel group (LCG) to which a logical channel (LCH) belongs. In a case where information for indicating a threshold for the LCG is included in the RRC message, the terminal apparatus is configured to trigger a delay status report based on a shortest remaining time of a discard timer for data becoming below the threshold for the LCG.

In one or more embodiments, a method of a terminal apparatus includes receiving, from a base station apparatus, a radio resource control (RRC) message including information for configuring an identifier (ID) of a logical channel group (LCG) to which a logical channel (LCH) belongs, and in a case where information for indicating a threshold for the LCG is included in the RRC message, triggering a delay status report based on a shortest remaining time of a discard timer for data becoming below the threshold for the LCG.

In one or more embodiments, a base station apparatus is configured to cause the base station apparatus to transmit, to a terminal apparatus, a radio resource control (RRC) message including information for configuring an identifier (ID) of a logical channel group (LCG) to which a logical channel (LCH) belongs. In a case where information for indicating a threshold for the LCG is included in the RRC message, the base station apparatus is configured to receive, from the terminal apparatus, a delay status report triggered based on a shortest remaining time of a discard timer for data becoming below the threshold for the LCG.

### BRIEF DESCRIPTION OF THE DRAWINGS

The above and other objects, features, and advantages of the present disclosure will become more apparent in the following detailed description with reference to the accompanying drawings, in which:

FIG. 1 is a diagram illustrating a communication system S according to a first embodiment;

FIG. 2 is a diagram illustrating a protocol stack in a U plane according to the first embodiment;

FIG. 3 is a diagram illustrating a protocol stack in a C plane according to the first embodiment;

FIG. 4 is a block diagram illustrating a schematic hardware configuration of a terminal apparatus 10 according to the first embodiment;

FIG. 5 is a block diagram illustrating a schematic functional configuration of the terminal apparatus 10 according to the first embodiment;

FIG. 6 is a block diagram illustrating a schematic hardware configuration of a base station apparatus 20 according to the first embodiment;

FIG. 7 is a block diagram illustrating a schematic functional configuration of the base station apparatus 20 according to the first embodiment;

FIG. 8 is a diagram illustrating a radio frame configuration according to the first embodiment;

FIG. 9 is a diagram illustrating a configuration of Short BSR;

FIG. 10 is a diagram illustrating a configuration of Long BSR;

FIG. 11 is a diagram for description of prioritization processing in a medium access control (MAC) layer;

FIG. 12 is a diagram for description of processing in a case where an uplink grant is considered to be de-prioritized, in the prioritization processing in the MAC layer;

FIG. 13 is a sequence diagram illustrating a process flow of the terminal apparatus 10 and the base station apparatus 20 according to the first embodiment;

FIG. 14 is a diagram illustrating an example of a configuration of Long BSR including delay information;

FIG. 15 is a diagram illustrating another example of the configuration of Long BSR including the delay information;

FIG. 16 is a diagram illustrating another example of the configuration of Long BSR including the delay information;

FIG. 17 is a diagram for description of autonomous transmission processing of the terminal apparatus 10;

FIG. 18 is a diagram illustrating a process flow of transmission of a delay information report according to the first embodiment;

FIG. 19 is a sequence diagram illustrating a process flow of a terminal apparatus 10 and a base station apparatus 20 according to a second embodiment;

FIG. 20 is a diagram for description of a situation where the delay information report is transmitted, according to a third embodiment;

FIG. 21 is a flowchart illustrating a process flow of transmission of the delay information report according to the third embodiment;

FIG. 22 is a flowchart illustrating another aspect of the process flow of transmission of the delay information report according to the third embodiment; and

FIG. 23 is a diagram for description of another aspect of the process flow of transmission of the delay information report according to the third embodiment.

### DETAILED DESCRIPTION

Hereinafter, embodiments of the present disclosure will be described in detail with reference to the accompanying drawings. Note that, in the Specification and drawings, elements to which similar descriptions are applicable are denoted by the same reference signs, and overlapping descriptions may hence be omitted.

Each embodiment described below is merely an example of a configuration that can implement the present disclosure. Each embodiment described below can be appropriately modified or changed according to a configuration of an apparatus to which the present disclosure is applied and various conditions. All of combinations of elements included in each embodiment described below are not necessarily required to implement the present disclosure, and a part of the elements can be appropriately omitted. Hence, the scope of the present disclosure is not limited by the configuration described in each embodiment described below. Configurations in which a plurality of configurations described in the embodiments below are combined can also be employed as long as the configurations are not inconsistent with each other.

### 1. First Embodiment

### 1.1. Communication System

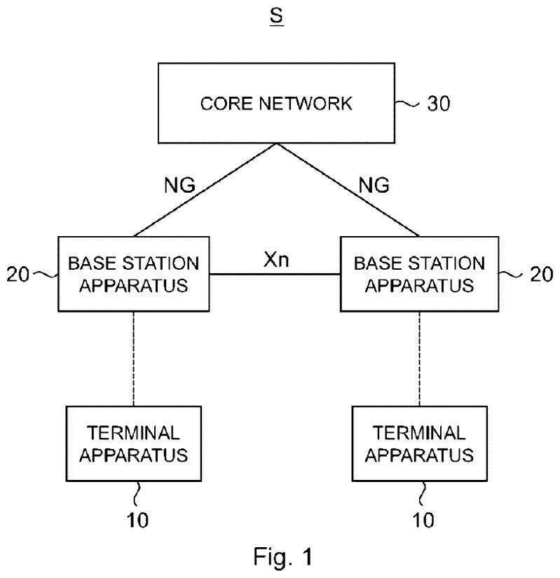

As illustrated in FIG. 1, a communication system S according to a first embodiment includes one or more terminal apparatuses 10, one or more base station apparatuses 20, and a core network 30. The communication system S is configured in accordance with certain technical specifications (TS). For example, the communication system S may be compliant with technical specifications defined by 3GPP (for example, 5G, 5G advanced, 6G, or the like).

In the communication system S, a user plane in which user data is transmitted and received and a control plane in which control data is transmitted and received are separately configured. In other words, the communication system S supports C/U split. The user plane is abbreviated to the U plane, and the control plane is abbreviated to the C plane.

The terminal apparatus 10 may be a device that performs radio communication with the base station apparatus 20, and may be, for example, a user equipment (UE) that operates in accordance with 5G NR specifications of 3GPP. The terminal apparatus 10 may be an apparatus that is compliant with other older or newer 3GPP specifications.

The terminal apparatus 10 may be, for example, a mobile phone terminal such as a smartphone, a tablet terminal, a notebook PC, a communication module, a communication card, or an IoT device such as a surveillance camera and a robot. The terminal apparatus 10 may be a vehicle (for example, a car, a train, or the like), or an apparatus mounted on the vehicle. The terminal apparatus 10 may be a transport machine body other than the vehicle (for example, a ship, an airplane, or the like), or an apparatus mounted on the transport machine body. The terminal apparatus 10 may be a sensor, or an apparatus provided with the sensor. Note that the terminal apparatus 10 may be referred to as another name such as a terminal, a mobile station, a mobile terminal, a mobile apparatus, a mobile unit, a subscriber station, a subscriber terminal, a subscriber apparatus, a subscriber unit, a wireless station, a wireless terminal, a wireless apparatus, a wireless unit, a remote station, a remote terminal, a remote apparatus, and a remote unit. The terminal apparatus 10 is preferably an apparatus adapted to one or more of enhanced mobile broadband (eMBB), ultra-reliable and low-latency communications (URLLC), and massive machine type communications (mMTC).

The base station apparatus 20 manages at least one cell. The cell configures a minimum unit of a communication area. For example, one cell belongs to one frequency (for example, carrier frequency), and is configured with one component carrier. The term “cell” may represent radio communication resources, and may represent a communication target of the terminal apparatus 10. The base station apparatus 20 performs radio communication with the terminal apparatus 10 existing in the cell of the base station apparatus 20 in the U plane and the C plane. In other words, the base station apparatus 20 terminates a U plane protocol and a C plane protocol for the terminal apparatus 10.

The base station apparatus 20 communicates with the core network 30 in the U plane and the C plane. More specifically, the core network 30 includes a plurality of logical nodes including an Access and Mobility Management Function (AMF) and a User Plane Function (UPF). The base station apparatus 20 connects to the AMF in the C plane, and connects to the UPF in the U plane.

The base station apparatus 20 may be a gNB that provides the terminal apparatus 10 with the U plane and the C plane conforming to 5G New Radio (NR) specifications of 3GPP and connects to a 5G core network (5GC) of 3GPP, for example. The base station apparatus 20 may be an apparatus conforming to other older or newer specifications of 3GPP.

The base station apparatus 20 may be configured by a plurality of unit apparatuses. For example, the base station apparatus 20 may include a central unit (CU), a distributed unit (DU), and a radio unit (RU).

With a configuration in which a plurality of base station apparatuses 20 are connected to each other, a radio access network (RAN) is formed. The radio access network formed by the base station apparatus 20 being a gNB may be referred to as an NG-RAN. The base station apparatus 20 being a gNB may be referred to as an NG-RAN node.

The plurality of base station apparatuses 20 are connected to each other by a predetermined interface (for example, an Xn interface). More specifically, for example, the plurality of base station apparatuses 20 are connected to each other by an Xn-U interface in the U plane, and are connected to each other by an Xn-C interface in the C plane. Note that the plurality of base station apparatuses 20 may be connected to each other by another interface having a different function and name.

Each base station apparatus 20 is connected to the core network 30 by a predetermined interface (for example, an NG interface). More specifically, for example, each base station apparatus 20 is connected to the UPF of the core network 30 by an NG-U interface in the U plane, and is connected to the AMF of the core network 30 by an NG-C interface in the C plane. Note that each base station apparatus 20 may be connected to the core network 30 by another interface having a different function and name.

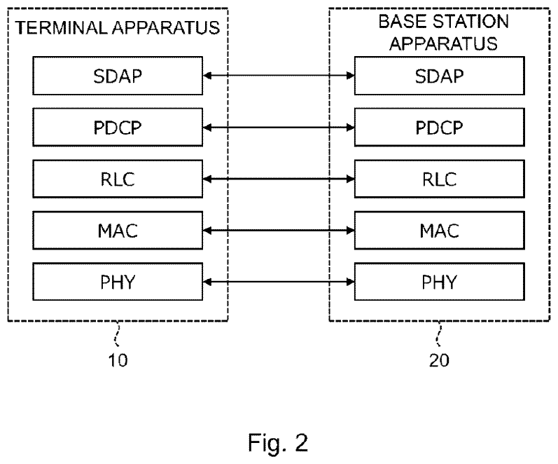

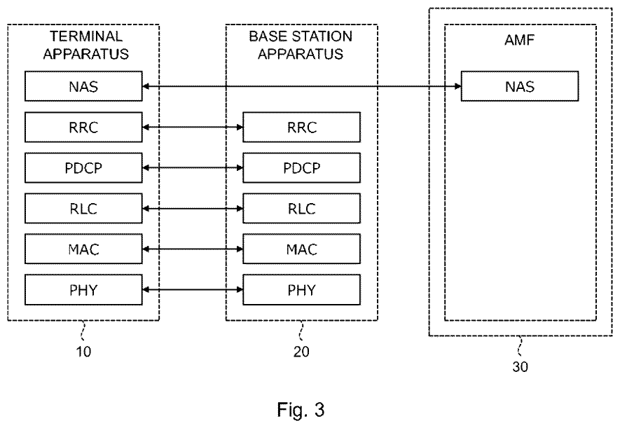

With reference to FIG. 2, a radio protocol architecture between the terminal apparatus 10 and the base station apparatus 20 will be described. With reference to FIG. 3, radio protocol architectures between the terminal apparatus 10 and the base station apparatus 20 and between the terminal apparatus 10 and the core network 30 will be described.

As illustrated in FIG. 2, a protocol stack in the U plane is provided with, in order from the lowest layer, a Physical (PHY) layer, a Media Access Control (MAC) layer, a Radio Link Control (RLC) layer, a Packet Data Convergence Protocol (PDCP) layer, and a Service Data Adaptation Protocol (SDAP) layer. Each of the layers is terminated in the base station apparatus 20 on the network side.

As illustrated in FIG. 3, a protocol stack in the C plane is provided with, in order from the lowest layer, a Physical (PHY) layer, a Media Access Control (MAC) layer, a Radio Link Control (RLC) layer, a Packet Data Convergence Protocol (PDCP) layer, a Radio Resource Control (RRC) layer, and a Non-Access Stratum (NAS). Each of the layers, except the Non-Access Stratum, is terminated in the base station apparatus 20 on the network side. The Non-Access Stratum is terminated in the AMF of the core network 30 on the network side.

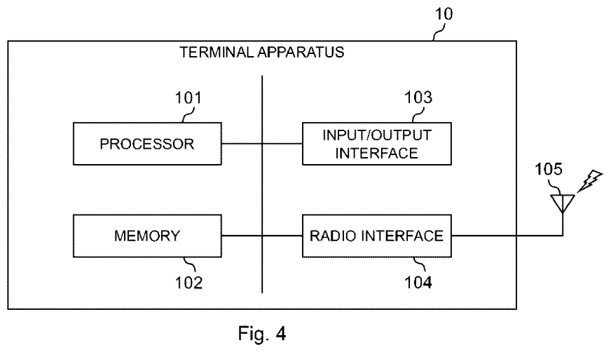

As illustrated in FIG. 4, the terminal apparatus 10 includes, as hardware elements, a processor 101, a memory 102, an input/output interface 103, a radio interface 104, and an antenna 105. The above elements provided in the terminal apparatus 10 are connected to each other via an internal bus. Note that the terminal apparatus 10 may include a hardware element other than the elements illustrated in FIG. 4.

The processor 101 is an arithmetic element that implements various functions of the terminal apparatus 10. The processor 101 may be a central processing unit (CPU), a graphics processing unit (GPU), and a system-on-a-chip (SoC) including an element such as a memory controller.

The memory 102 includes at least one storage medium, such as a random access memory (RAM) and an embedded multi media card (eMMC). The memory 102 is an element that temporarily or permanently stores a program and data used to execute various types of processing in the terminal apparatus 10. The program includes one or more instructions for operations of the terminal apparatus 10. The processor 101 deploys the program stored in the memory 102 into the memory 102 itself and/or a system memory (not illustrated), and executes the program to thereby implement the functions of the terminal apparatus 10.

The input/output interface 103 is an interface that receives an operation to the terminal apparatus 10 and supplies the operation to the processor 101, and presents various pieces of information to a user. The input/output interface 103 is a touch panel, for example.

The radio interface 104 is a circuit that executes various types of signal processing for implementing radio communication, and includes a baseband processor and an RF circuit. The radio interface 104 transmits and receives a radio signal to and from the base station apparatus 20 via the antenna 105.

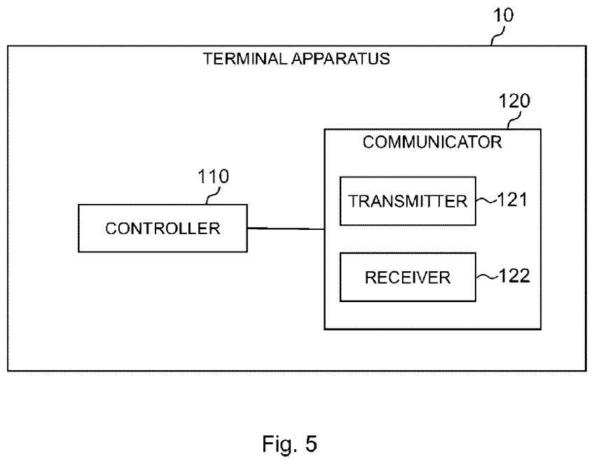

As illustrated in FIG. 5, the terminal apparatus 10 includes, as functional blocks, a controller 110 and a communicator 120. The communicator 120 includes at least one transmitter 121 and at least one receiver 122.

The controller 110 may include at least one processor 101 and at least one memory 102. In other words, the controller 110 may be implemented by the processor 101 and the memory 102. The controller 110 executes various types of control processing in the terminal apparatus 10. For example, the controller 110 controls radio communication with the base station apparatus 20 via the communicator 120. In other words, the controller 110 performs, via the communicator 120, transmission/reception of data/information/message.

The communicator 120 includes the radio interface 104 and the antenna 105. In other words, the communicator 120 is implemented by the radio interface 104 and the antenna 105. The communicator 120 transmits and receives a radio signal to and from the base station apparatus 20, and thereby performs radio communication with the base station apparatus 20. The communicator 120 may include two or more radio interfaces 104 and two or more antennas 105.

When the controller 110 operates, the various types of processing of the terminal apparatus 10 according to the present embodiment are executed.

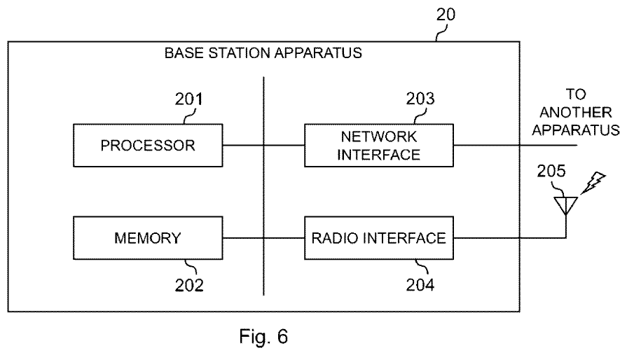

As illustrated in FIG. 6, the base station apparatus 20 includes, as hardware elements, a processor 201, a memory 202, a network interface 203, a radio interface 204, and an antenna 205. The above elements provided in the base station apparatus 20 are connected to each other via an internal bus. Note that the base station apparatus 20 may include a hardware element other than the elements illustrated in FIG. 6.

The processor 201 is an arithmetic element that implements various functions of the base station apparatus 20. The processor 201 may be a CPU, and may further include another processor such as a GPU.

The memory 202 includes at least one storage medium, such as a read only memory (ROM), a RAM, a hard disk drive (HDD), and a solid state drive (SSD). The memory 202 is an element that temporarily or permanently stores a program and data used to execute various types of processing in the base station apparatus 20. The program includes one or more instructions for operations of the base station apparatus 20. The processor 201 deploys the program stored in the memory 202 into the memory 202 itself and/or a system memory (not illustrated), and executes the program to thereby implement the functions of the base station apparatus 20.

The network interface 203 is an interface used to transmit and receive a signal to and from another base station apparatus 20 and the core network 30.

The radio interface 204 is a circuit that executes various types of signal processing for implementing radio communication, and includes a baseband processor and an RF circuit. The radio interface 204 transmits and receives a radio signal to and from the terminal apparatus 10 via the antenna 205.

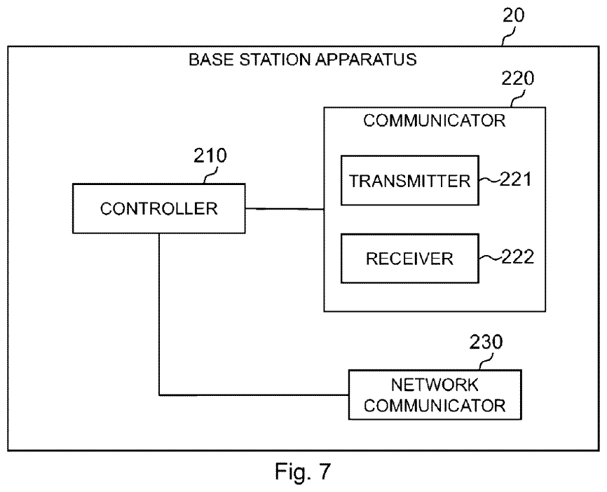

As illustrated in FIG. 7, the base station apparatus 20 includes, as functional blocks, a controller 210, a communicator 220, and a network communicator 230. The communicator 220 includes at least one transmitter 221 and at least one receiver 222.

The controller 210 may include at least one processor 201 and at least one memory 202. In other words, the controller 210 may be implemented by the processor 201 and the memory 202. The controller 210 executes various types of control processing in the base station apparatus 20. For example, the controller 210 controls radio communication with the terminal apparatus 10 via the communicator 220. In other words, the controller 210 performs, via the communicator 220, transmission/reception of data/information/message. For example, the controller 210 controls communication with another node (for example, another base station apparatus 20, a node of the core network 30) via the network communicator 230.

The communicator 220 includes the radio interface 204 and the antenna 205. In other words, the communicator 220 is implemented by the radio interface 204 and the antenna 205. The communicator 220 transmits and receives a radio signal to and from the terminal apparatus 10, and thereby performs radio communication with the terminal apparatus 10. The communicator 220 may include two or more radio interfaces 204 and two or more antennas 205.

The network communicator 230 includes the network interface 203. In other words, the network communicator 230 is implemented by the network interface 203. The network interface 203 transmits and receives a signal to and from the network (ultimately, another node described above).

When the controller 210 operates, the various types of processing of the base station apparatus 20 according to the present embodiment are executed.

### 1.2. Radio Resources

The terminal apparatus 10 and the base station apparatus 20 perform radio communication with each other, using radio resources in the frequency domain and the time domain. The radio resources will be described below.

A transmission method of downlink communication from the base station apparatus 20 to the terminal apparatus 10 is, for example, orthogonal frequency division multiplexing (OFDM) using a cyclic prefix (CP), that is, CP-OFDM. A transmission method of uplink communication from the terminal apparatus 10 to the base station apparatus 20 is, for example, CP-OFDM described above, or DFTS-OFDM in which CP-OFDM is applied subsequently to transform precoding for performing discrete Fourier transform (DFT) spreading.

The cyclic prefix is a redundant signal that functions as a guard period (GP) for preventing inter-symbol interference and inter-carrier interference, and is inserted at the start of an OFDM symbol. Types of the cyclic prefix include a normal cyclic prefix and an extended cyclic prefix.

As the radio resources in the frequency domain of OFDM, a plurality of subcarriers being orthogonal to each other are used. The plurality of subcarriers are allocated with a predetermined subcarrier spacing (sub-carrier spacing (SCS)) Δf in the frequency domain. In the communication system S, a plurality of subcarrier spacings Δf may be applied. The subcarrier spacing Δf is expressed by the following expression, for example.

$$Δ f = {2}^{μ} \cdot 15 [ kHz ]$$

Here, μ is an integer of 0 or greater, and may be any one of values of 0, 1, 2, 3, 4, 5, and 6. Accordingly, the subcarrier spacing Δf [kHz] may be any one of values of 15, 30, 60, 120, 240, 480, and 960. Note that μ may be a value of 7 or greater.

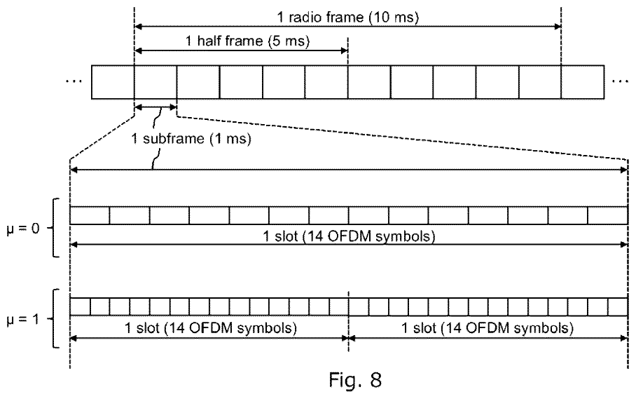

In the time domain of OFDM, as illustrated in FIG. 8, a hierarchical radio frame configuration is used. One radio frame includes 10 subframes. The subframes are numbered with subframe numbers counting up from 0 to 9 by one. One radio frame is divided into two half frames. A time length of the radio frame is 10 ms, a time length of the half frame is 5 ms, and a time length of the subframe is 1 ms. The above time lengths are not dependent upon the subcarrier spacing Δf.

One subframe includes one or more slots. The number Ns of slots included in one subframe is dependent upon the value of μdescribed above, ultimately the subcarrier spacing Δf. The number Ns of slots is expressed by the following expression, for example.

$$Ns = {2}^{μ}$$

One slot includes a plurality of symbols. The number of symbols included in one slot is dependent upon the type of cyclic prefix. For example, in a configuration in which the normal cyclic prefix is used, one slot includes 14 symbols. For example, in a configuration in which the extended cyclic prefix is used, one slot includes 12 symbols.

As described above, the number of slots and the number of symbols included in each of the radio frame, the half frame, and the subframe having a fixed time length are variable. Accordingly, the time length of the slot and the time length of the symbol are also variable.

A resource element (RE) is a radio resource unit in the time-frequency domain including one subcarrier and one symbol. A resource block (RB) is a radio resource unit in the time-frequency domain including 12 subcarriers and a plurality of symbols.

The radio frames are assigned system frame numbers (SFNs) counted up from 0 to 1023in increments of 1. The SFN “0” corresponds to an initial SFN value, and the SFN “1023” corresponds to the largest SFN value. Hence, SFN 0 is assigned to a radio frame that follows a radio frame assigned SFN 1023. The time length of the radio frame is 10 ms, and accordingly the time length of one cycle of the system frame number is 10240 ms (=10.24 seconds).

Here, the base station apparatus 20 may configure one or a plurality of serving cells for the terminal apparatus 10. The serving cell may correspond to a downlink component carrier and/or an uplink component carrier. A technology in which one or a plurality of serving cells are configured and the base station apparatus 20 and the terminal apparatus 10 perform radio communication may also be referred to as carrier aggregation.

The base station apparatus 20 may configure one or a plurality of bandwidth parts (BWPs) for the terminal apparatus 10 for each of one or a plurality of serving cells. For example, in the downlink of one serving cell, a downlink bandwidth part (DL-BWP) may be configured. In the uplink of one serving cell, an uplink bandwidth part (UL-BWP) may be configured. Here, the DL-BWP may include an initial DL-BWP and/or a dedicated DL-BWP. The UL-BWP may include an initial UL-BWP and/or a dedicated UL-BWP. In the following, the BWP may include the DL-BWP and/or the UL-BWP.

### 1.3. Channels and Control Information

The terminal apparatus 10 and the base station apparatus 20 transmit and receive user data and control information to and from each other. Transmission and reception of downlink and uplink control information will be illustrated below.

The terminal apparatus 10 and the base station apparatus 20 transmit and receive user data and control information, using a plurality of hierarchical channels. A physical channel is a channel used for physical communication between the terminal apparatus 10 and the base station apparatus 20. Examples of physical channels include a physical downlink control channel (PDCCH), a physical broadcast channel (PBCH), and a physical uplink control channel (PUCCH).

A transport channel is a channel located higher than the physical channel, and is mapped to the physical channel in a PHY layer. A plurality of transport channels may be mapped to one physical channel. Examples of the transport channel include a downlink common channel (DownLink Shared Channel, DL-SCH) and an uplink common channel (UpLink Shared Channel, UL-SCH). For example, data in downlink is also referred to as data of the DL-SCH. For example, data in uplink is also referred to as data of the UL-SCH. Here, the data of the DL-SCH includes user data in downlink. The data of the UL-SCH includes user data in uplink.

A logical channel is a channel located higher than the transport channel, and is mapped to the transport channel in the MAC layer. A plurality of logical channels may be mapped to one transport channel, and one logical channel may be mapped to a plurality of transport channels. The logical channels are classified by characteristics of information to be transmitted. Examples of logical channels include a broadcast control channel (BCCH), a common control channel (CCCH), and a dedicated control channel (DCCH).

The base station apparatus 20 transmits downlink control information (DCI) to the terminal apparatus 10, using the PDCCH being a physical channel. The DCI includes information related to downlink and uplink resource allocations to the terminal apparatus 10 and other control information of the terminal apparatus 10. The DCI is mapped to the PDCCH, and corresponds to layer 1 signaling.

Here, regarding transmission of the DCI on the PDCCH, one or a plurality of formats may be defined. A format defined regarding transmission of the DCI on the PDCCH may be referred to as a DCI format. For example, the DCI format may include a DCI format (for example, a format referred to as DCI format 1_0, DCI format 1_1, and/or DCI format 1_2) used for scheduling of a physical downlink shared channel (PDSCH). For example, the DCI format may include a DCI format (for example, a format referred to as DCI format 0_0, DCI format 0_1, and/or DCI format 0_2) used for scheduling of a physical uplink shared channel (PUSCH). The DCI format may include a DCI format not used for scheduling of the PDSCH and/or the PUSCH. The DCI format used for scheduling of the PDSCH and/or the PUSCH may be referred to as a scheduling DCI format. The DCI format not used for scheduling of the PDSCH and/or the PUSCH may be referred to as a non-scheduling DCI format. In the present embodiment, for the sake of simplicity of description, the “DCI format” may be simply referred to as the “PDCCH”. The “DCI generated according to the DCI format” may be simply referred to as the “DCI format”.

For example, the base station apparatus 20 may configure frequency domain resources and/or time domain resources for the terminal apparatus 10 to monitor a PDCCH candidate set. For example, the frequency domain resources in which the terminal apparatus 10 monitors the PDCCH candidate set may be referred to as a control resource set (CORESET). The time domain resources in which the terminal apparatus 10 monitors the PDCCH candidate set may be referred to as a search space set (SSS). The terminal apparatus 10 may monitor the PDCCH candidate set in one or a plurality of CORESETs in the DL-BWP of the serving cell configured with PDCCH monitoring according to a corresponding search space set. Here, to monitor may connote to attempt to decode each of the PDCCH candidates according to the monitored DCI format. The configuration described above may be referred to as blind decoding.

Here, a cyclic redundancy check (CRC) scrambled using a radio network temporary identifier (RNTI) may be added to the DCI (or the DCI format) to be transmitted on the PDCCH. The CRC may also be referred to as a CRC parity bit. A plurality of types of RNTIs are defined. For example, the base station apparatus 20 may transmit an RRC message including at least one of information indicating a Cell-RNTI (C-RNTI), information indicating a Modulation and Coding Scheme Cell-RNTI (MCS-C-RNTI), and information indicating a Configured Scheduling-RNTI (CS-RNTI) to thereby configure each RNTI. In other words, a CRC scrambled using at least one of the C-RNTI, the MCS-C-RNTI, and the CS-RNTI may be added to the DCI (or the DCI format) to be transmitted on the PDCCH.

The terminal apparatus 10 may monitor (and/or receive) the PDCCH and detect (and/or receive) the DCI format.

The terminal apparatus 10 transmits, to the base station apparatus 20, uplink control information (UCI) by using a PUCCH being a physical channel. The UCI includes control information such as a scheduling request (SR), an Ack/Nack in hybrid automatic repeat request (HARQ), and channel state information (CSI). The UCI is mapped to the PUCCH or the PUSCH, and corresponds to Layer 1 signaling.

The base station apparatus 20 transmits, to the terminal apparatus 10, a control element (CE) of a MAC layer by using a DL-SCH being a transport channel. The downlink MAC CE is mapped to a PDSCH via the DL-SCH, and corresponds to Layer 2 signaling.

The terminal apparatus 10 transmits, to the base station apparatus 20, a control element (CE) of a MAC layer by using a UL-SCH being a transport channel. The uplink MAC CE includes control information such as buffer status reporting (BSR). The uplink MAC CE is mapped to a PUSCH via the UL-SCH, and corresponds to Layer 2 signaling.

The base station apparatus 20 transmits (or broadcasts) system information (SI) to the terminal apparatus 10, using the BCCH being a logical channel. The SI includes minimum system information (MSI) and other system information (OSI). The MSI includes a master information block (MIB) and a system information block 1 (SIB1). The SIB1 may be referred to as remaining minimum system information (RMSI). The OSI includes system information blocks (from SIB2), other than the SIB1. Of the BCCH, the MIB is mapped to the PBCH via the broadcast channel (BCH), and the SIB is mapped to the PDSCH via the DL-SCH.

The base station apparatus 20 transmits control information in the RRC layer to the terminal apparatus 10, using a signaling radio bearer (SRB) established between the terminal apparatus 10 and the base station apparatus 20 in the RRC layer. A message exchanged between the base station apparatus 20 and the terminal apparatus 10 in the RRC layer may be hereinafter referred to as an RRC message. A plurality of types of SRBs (for example, SRB0, SRB1, SRB2, SRB3, and SRB4) are present. The SRB is used to transmit and receive a NAS message including control information in the NAS layer, other than the RRC message. To transmit the RRC message from the base station apparatus 20 to the terminal apparatus 10, the CCCH or the DCCH is used. The CCCH and the DCCH are each mapped to the PDSCH via the DL-SCH. The RRC message corresponds to layer 3 signaling.

As an example of a downlink RRC message, an RRC reconfiguration (RRCReconfiguration) message will be described. The RRC reconfiguration message is an RRC message transmitted from the base station apparatus 20 to the terminal apparatus 10 using SRB1 or SRB3. The DCCH is used to transmit the RRC reconfiguration message. The RRC reconfiguration message is used to perform reconfiguration or modification of connection between the base station apparatus 20 and the terminal apparatus 10.

The terminal apparatus 10 transmits the RRC message to the base station apparatus 20, using the SRB described above. To transmit the RRC message from the terminal apparatus 10 to the base station apparatus 20, the CCCH or the DCCH is used. The CCCH and the DCCH are each mapped to the PUSCH via the UL-SCH. The RRC message corresponds to layer 3 signaling.

As an example of an uplink RRC message, a user equipment capability information (UECapabilityInformation) message will be described. The user equipment capability information message is an RRC message transmitted from the terminal apparatus 10 to the base station apparatus 20 using SRB1. The DCCH is used to transmit the user equipment capability information message. The user equipment capability information message is used to notify the base station apparatus 20 of information related to a radio access capability of the terminal apparatus 10.

As an example of an uplink RRC message, a user equipment assistance information (UEAssistanceInformation) message will be described. The user equipment assistance information message is an RRC message transmitted from the terminal apparatus 10 to the base station apparatus 20 using SRB1 or SRB3. The DCCH is used to transmit the user equipment assistance information message. The user equipment assistance information message is used to notify the base station apparatus 20 of various pieces of information (UE assistance information) related to the terminal apparatus 10.

### 1.4. Uplink Scheduling

### 1.4.1. Scheduling Request (SR)

An SR is used for the terminal apparatus 10 to request PUSCH radio resource allocation from the base station apparatus 20. An SR may be used for request of a UL-SCH resource for initial transmission. The base station apparatus 20 allocates, to the terminal apparatus 10, a PUCCH resource for transmission of the SR. The base station apparatus 20 transmits, to the terminal apparatus 10, an RRC message including a parameter for the SR. The parameter for the SR is included in an information element (IE) “SchedulingRequestResourceConfig” being an example of an IE for RRC.

The terminal apparatus 10 transmits, to the base station apparatus 20, UCI including the SR by using the configured PUCCH resource. The terminal apparatus 10 may transmit the UCI on demand. The terminal apparatus 10 may transmit the UCI with a configured periodicity. For example, the terminal apparatus 10 may transmit the SR set to “0” (negative SR) and/or the SR set to “1” (positive SR). In accordance with the SR, the base station apparatus 20 allocates a PUSCH radio resource to the terminal apparatus 10.

### 1.4.2. Dynamic Grant (DG)

A DG is a scheduling method of allocating a PUSCH radio resource in accordance with an uplink grant procedure. The base station apparatus 20 transmits, to the terminal apparatus 10, an uplink grant on a PDCCH. The terminal apparatus 10 performs transmission of a PUSCH in accordance with the uplink grant. For example, the base station apparatus 20 may allocate a PUSCH radio resource by using a C-RNTI and/or a DCI format with a CRC scrambled with an MCS-C-RNTI (i.e., DCI format used for scheduling of the PUSCH), and the terminal apparatus 10 may perform uplink transmission by using the PUSCH radio resource allocated. Here, a new data indicator to be included in the C-RNTI and/or the DCI format with the CRC scrambled with the MCS-C-RNTI may be set to 0 or 1. The base station apparatus 20 may allocate a PUSCH radio resource by using a DCI format with a CRC scrambled with a CS-RNTI (i.e., DCI format used for scheduling of the PUSCH), and the terminal apparatus 10 may perform uplink transmission by using the PUSCH radio resource allocated. A new data indicator to be included in the DCI format with the CRC scrambled with the CS-RNTI may be set to 1.

### 1.4.3. Configured Grant (CG)

A CG is a scheduling method of allocating a PUSCH radio resource without the dynamic uplink grant procedure. The CG includes two types, type 1 and type 2. The base station apparatus 20 transmits, to the terminal apparatus 10, an RRC message including a parameter for the CG. The parameter for the CG is included in an information element (IE) “ConfiguredGrantConfig” being an example of an IE for RRC. The IE “ConfiguredGrantConfig” includes a parameter “periodicity” related to a periodicity of transmission using a PUSCH. Note that the parameter “periodicity” is configured in units of the number of slots or number of symbols. Alternatively, the parameter “periodicity” may be configured in units of Frame Per Second (FPS). For type 1, the terminal apparatus 10 initiates transmission of a signal with a configured periodicity, without any trigger by DCI. In contrast, for type 2, the base station apparatus 20 transmits, to the terminal apparatus 10, DCI scrambled with a CS-RNTI. The CS-RNTI is used for activation of periodic transmission. In accordance with such activation by the DCI scrambled with the CS-RNTI, the terminal apparatus 10 initiates transmission using a PUSCH with a configured periodicity.

### 1.5. Hybrid Automatic Repeat Request (HARQ)

HARQ is a mechanism to control error correction and retransmission request. When a reception side (receiver) detects an error in data received from a transmission side (sender), the receiver requests retransmission of the data from the sender. The receiver combines the previously received data and the retransmitted data for acquisition of data.

Note that the HARQ is a Stop-And-Wait (SAW) protocol. When having received data correctly, the receiver transmits Acknowledgement (Ack) to the sender. The sender, having received Ack, transmits next data. As described above, in the HARQ, the sender cannot transmit any next data until the receiver completes reception of data.

In the following, a case is described that a transmission occasion for a PUSCH is configured by using a CG.

The base station apparatus 20 may transmit, to the terminal apparatus 10, an RRC message including a parameter related to a PUSCH. The parameter related to the PUSCH is included in “PUSCH-ServingCellConfig” IE being an example of an information element (IE) for RRC.

A HARQ entity in the terminal apparatus 10 may have one or more HARQ processes. For uplink transmission, the terminal apparatus 10 supports, per cell, 16 or 32 HARQ processes at maximum. The number of HARQ processes is configured using “nrofHARQ-ProcessesForPUSCH” included in the parameter related to the PUSCH (i.e., “PUSCH-ServingCellConfig” IE). In a case where “nrofHARQ-ProcessesForPUSCH” is absent in the “PUSCH-ServingCellConfig” IE, the number of HARQ processes is configured to be 16 as a default.

In a case of uplink transmission, each HARQ process supports one transport block (TB). In other words, one TB is transmitted in one transmission occasion. One HARQ process identifier is associated with (or allocated to) one HARQ process. Hereinafter, the HARQ process identifier is referred to as “HPI”.

### 1.6. Buffer Status Report (Buffer Status Reporting (BSR))

The terminal apparatus 10 transmits, using an allocated PUSCH radio resource, a BSR by using MAC signaling. The BSR is configured with a MAC CE included in a medium access control protocol data unit (MAC PDU). The BSR indicates information related to a buffer status of uplink data of a MAC entity. Based on the BSR, the base station apparatus 20 performs radio resource allocation for uplink with respect to the terminal apparatus 10.

In the BSR, a logical channel (LCH) is allocated to a logical channel group (LCG). Each LCG includes one or more logical channels. The terminal apparatus 10 calculates, for each LCG, a buffer size of uplink data. The terminal apparatus 10 transmits, to the base station apparatus 20, the buffer size corresponding to each LCG as the BSR.

The base station apparatus 20 transmits, to the terminal apparatus 10, an RRC message including a parameter for the BSR. The parameter for the BSR is included in an information element (IE) “BSR-Config” being an example of an IE for RRC. For example, the IE “BSR-Config” includes three timers, “periodicBSR-Timer”, “retxBSR-Timer”, and “logicalChannelSR-DelayTimer”.

A parameter associated with an LCG is included in an information element (IE) “LogicalChannelConfig” being an example of an IE for RRC. In other words, the base station apparatus 20 may transmit an RRC message including the IE “LogicalChannelConfig”. Based on the IE “LogicalChannelConfig” included in the RRC message, the terminal apparatus 10 may identify a configuration related to a logical channel and/or LCG. For example, the IE “LogicalChannelConfig” includes an IE “logicalChannelGroup”. With the IE “logicalChannelGroup”, a logical channel is allocated to an LCG. For example, for each of one or a plurality of logical channels, an LCG index (ID) may be configured, and an LCG that such one or a plurality of logical channels belong to may be configured. Note that the IE “LogicalChannelConfig” may include an IE “logicalChannelGroupIAB-Ext”. The IE “logicalChannelGroupIAB-Ext” is applied only to an Integrated Access Backhaul-Mobile Termination (IAB-MT). In a case where the IE “logicalChannelGroupIAB-Ext” is configured, the IE “LogicalChannelConfig” is ignored.

The terminal apparatus 10 may trigger the BSR in accordance with a certain condition. For example, for an activated cell group, the terminal apparatus 10 may trigger the BSR when any of the following conditions (a1) to (a4) is satisfied. Note that the following conditions may be referred to as “events”.
(a1) For a logical channel belonging to a certain LCG, uplink data becomes available to a MAC entity, and either one of the following two is satisfied:
   the uplink data belongs to a logical channel with higher priority than the priorities of any logical channels including available uplink data that belong to any LCG; or
   none of the logical channels that belong to an LCG includes any available uplink data.
(a2) Uplink resources are allocated and the number of padding bits is equal to or larger than a size of a BSR MAC CE plus its subheader.
(a3) “retxBSR-Timer” expires and at least one of the logical channels belonging to an LCG includes uplink data.
(a4) “periodicBSR-Timer” expires.

The BSR includes Regular BSR, Padding BSR, and Periodic BSR, at least. Regular BSR, Padding BSR, and Periodic BSR may each be triggered based on a different condition. For example, the terminal apparatus 10 triggers Regular BSR in a case where either of the condition (a1) or (a3) is satisfied. The terminal apparatus 10 triggers Padding BSR in a case where the condition (a2) is satisfied. The terminal apparatus 10 triggers Periodic BSR in a case where the condition (a4) is satisfied.

The BSR includes a plurality of formats. The plurality of formats include Short BSR and Long BSR, at least. A MAC PDU including the BSR includes a MAC subheader. The MAC subheader includes a logical channel identifier (LCID) or an extended logical channel identifier (eLCID). The value of LCID or eLCID may be referred to as a codepoint. Short BSR and Long BSR are each identified by a codepoint value.

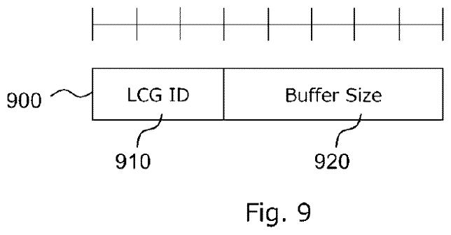

Short BSR is a format for reporting of a buffer status (i.e., buffer size) of one LCG. As illustrated in FIG. 9, the Short BSR includes one field 900 having a fixed size of 8 bits. The field 900 includes a first part 910 and a second part 920.

The first part 910 consists of 3 bits. The first part 910 is information for identification of an LCG whose buffer status is to be reported. The first part 910 may be referred to as “LCG ID field”.

The second part 920 consists of 5 bits. The second part 920 is information for identification of the total amount of data available for all the logical channels included in the LCG indicated by the first part 910. The second part 920 may be simply referred to as “buffer size”. The second part 920 indicates an index indicating the number of bytes. For example, the second part 920 indicates any one of values 0 to 31.

Note that Short BSR may include Truncated format and Extended format, the Truncated format being a format for a high priority logical channel (the priority herein corresponds to LCH priority described later) and the Extended format being a format that allows more amount of information to be transmitted.

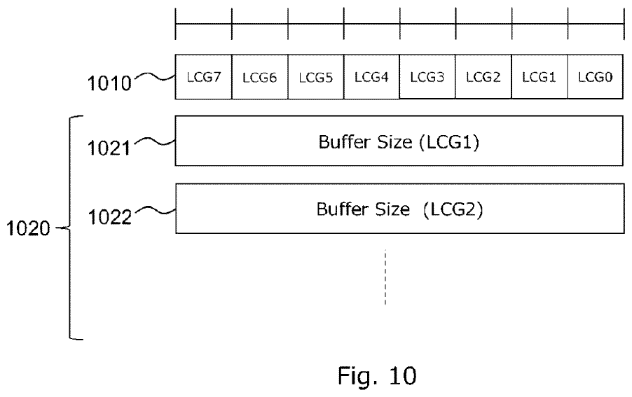

Long BSR is a format for reporting of buffer statuses (i.e., buffer sizes) of a plurality of LCGs. As illustrated in FIG. 10, the Long BSR has a variable size. The Long BSR includes an LCG field 1010 and a buffer size field 1020.

The LCG field 1010 consists of 8 bits. In the LCG field 1010, the 8 bits correspond to the respective eight LCGi. Here, i is an integer from 0 to 7. The same definition of i applies to the description hereinafter. The LCG field 1010 may indicate whether a buffer size field for LCGi is present. For example, in a case where, in the LCG field 1010, the value of LCGi is 1, this indicates presence of the buffer size field corresponding to LCGi. In a case where the value of LCGi is 0, this indicates absence of the buffer size field corresponding to LCGi.

The number of fields included in the buffer size field 1020 is variable depending on the value of the LCG field 1010. In the example of FIG. 10, in the LCG field 1010, it is assumed that a bit corresponding to LCG 1 is 1 and a bit corresponding to LCG 2 is 1. Thus, the buffer size field 1020 includes a field 1021 corresponding to LCG 1 and a field 1022 corresponding to LCG 2. Note that, since a bit corresponding to LCG 0 is assumed to be 0 in FIG. 10, no field corresponding to LCG 0 is included in the buffer size field 1020.

Each field included in the buffer size field 1020 consists of 8 bits. Each field indicates an index indicating the number of bytes. For example, each field indicates any one of values 0 to 254.

Note that, similarly to Short BSR, Long BSR may include Truncated format and Extended format.

The BSR may include Pre-emptive BSR format and Extended Pre-emptive BSR format. These formats are used for an IAB-MT.

The terminal apparatus 10 may select either Short BSR or Long BSR, in accordance with a certain method. For example, in a case of Regular BSR and Periodic BSR, the terminal apparatus 10 may select either Short BSR or Long BSR as below. In a case where two or more LCGs have data (available data) available for transmission when a MAC PDU including a BSR is built, the terminal apparatus 10 transmits Long BSR for all the LCGs having the available data. Otherwise, the terminal apparatus 10 transmits Short BSR.

In a case of Regular BSR and Periodic BSR, with respect to a MAC entity configured with an IE “logicalChannelGroup-IABExt” by an upper layer, the terminal apparatus 10 may select either Short BSR or Long BSR as below. In a case where two or more LCGs have data available for transmission and the maximum value of LCG ID among the configured LCGs is 7 or lower, the terminal apparatus 10 transmits Long BSR for all the LCGs having the available data. In a case where two or more LCGs have data available for transmission and the maximum value of LCG ID among the configured LCGs is higher than 7, the terminal apparatus 10 transmits Extended Long BSR for all the LCGs having the available data. In a case where one or more LCGs have data available for transmission, the terminal apparatus 10 transmits Extended Short BSR.

In a case of Padding BSR, the terminal apparatus 10 may transmit, in accordance with a condition to be satisfied, any one of the following BSR formats.
Short BSR
Long BSR
Short Truncated BSR
Long Truncated BSR
Extended Short Truncated BSR
Extended Long Truncated BSR

### 1.7. Logical Channel Prioritization (LCP) Procedure

The terminal apparatus 10 generates a MAC PDU for an uplink transmission in accordance with an uplink grant from the base station apparatus 20. The terminal apparatus 10 multiplexes data segments from a plurality of different LCHs to generate the MAC PDU. In this, the terminal apparatus 10 generates the MAC PDU in accordance with an LCP procedure. The LCP procedure is processing for multiplexing of data segments from a plurality of different LCHs. The LCP procedure may be the procedure described in Clause 5.4.3.1 of 3GPP TS 38.321 V 17.2.0 (2022-09).

For example, the base station apparatus 20 may transmit an RRC message including a “LogicalChannelConfig” IE. The terminal apparatus 10 may generate the MAC PDU, based on the “LogicalChannelConfig” IE included in the RRC message. The “LogicalChannelConfig” IE may include the following parameters.
priority: a value in a range from 1 to 16 to denote a priority. The smaller the value the higher the priority. Hereinafter, the priority is referred to as “LCH priority”, in order to be distinguished from other priorities (for example, PHY priority).
prioritizedBitRate (PBR): which denotes a bit rate guaranteed at minimum.
bucketSizeDuration (BSD): which denotes a bucket size duration. The bucket size is determined by PBR ×BSD.

For example, the terminal apparatus 10 may generate the MAC PDU by performing the LCP procedure as below. The terminal apparatus 10 allocates, in the LCH priority order, data amount guaranteed by the PBR of each LCH to a resource in the MAC PDU. In a case where there is an available resource in the MAC PDU even after the allocation of data guaranteed by the PBR with respect to every LCH, the terminal apparatus 10 allocates, in the LCH priority order, data of the LCH to the available resource in the MAC PDU. The terminal apparatus 10 performs the procedure as described above until data of every LCH runs out or available resources in the MAC PDU run out.

Note that, in the LCP procedure, MAC CEs are basically prioritized as compared with data from LCHs. Thus, the terminal apparatus 10 may allocate a MAC CE to a resource in the MAC PDU, before allocation of data from the LCH. Note that a specific type of MAC CE may not be prioritized as compared with data from the LCH. For example, Padding BSR may have a priority lower than the priority of data from the LCH.

In the LCP procedure, the base station apparatus 20 can configure, for the terminal apparatus 10, a mapping restriction. The mapping restriction may be the restriction described in Clause 5.4.3.1 of 3GPP TS 38.321 V 17.2.0 (2022-09). A MAC entity of the terminal apparatus 10 may select data of an LCH to be allocated to a resource in the MAC PDU, in accordance with the mapping restriction.

The terminal apparatus 10 may perform the mapping restriction, based on the “LogicalChannelConfig” IE included in the RRC message. The “LogicalChannelConfig” IE may include at least one of the following parameters.
allowedSCS-List: which denotes an allowed subcarrier spacing(s) for transmission.
maxPUSCH-Duration: which denotes a maximum PUSCH duration allowed for transmission.
configuredGrantType1Allowed: which denotes whether CG type 1 can be used for transmission.
allowedServingCells: which denotes an allowed cell(s) for transmission.
allowedCG-List: which denotes an allowed CG(s) for transmission.
allowedPHY-PriorityIndex: which denotes an index of an allowed PHY priority of a DG for transmission. Note that details of the PHY priority is described later below.
allowedHARQ-mode: which denotes an allowed uplink HARQ mode for transmission.

For example, in a case where “allowedCG-List” is configured for a certain LCH, the terminal apparatus 10 can map data of the LCH only to a MAC PDU corresponding to a CG included in such “allowedCG-List”.

### 1.8. Intra-UE Prioritization Processing

In a case where a plurality of uplink transmissions with different delay requirements and/or reliability requirements have an overlap in a time resource, the terminal apparatus 10 may transmit an uplink transmission with a high priority and stop (or cancel) an uplink transmission with a low priority. Such processing is referred to as intra-UE prioritization processing. The intra-UE prioritization processing may include processing in a MAC layer and processing in a PHY layer. Hereinafter, the processing in the MAC layer is referred to as “MAC layer prioritization processing” or “first prioritization processing”, and the processing in the PHY layer is referred to as “PHY layer prioritization processing” or “second prioritization processing”.

### 1.8.1 MAC Layer Prioritization Processing

The base station apparatus 20 may transmit, to the terminal apparatus 10, a configuration for activating the MAC layer prioritization processing (i.e., first prioritization processing). For example, the configuration may be configured for a MAC cell group. The configuration may be configured for an IE associated with the MAC cell group included in an RRC message. Examples of such an IE may include a “MAC-CellGroupConfig” IE. The configuration may be “lch-BasedPrioritization” included in the “MAC-CellGroupConfig” IE. The “lch-BasedPrioritization” indicates the first prioritization processing based on the LCH priorities is performed.

In a case where “lch-BasedPrioritization” is present in the “MAC-CellGroupConfig” IE, a MAC entity of the terminal apparatus 10 may perform the first prioritization processing between a plurality of uplink transmissions having an overlap in a time resource. The terminal apparatus 10 may determine a final priority with respect to each uplink transmission, based on the LCH priorities. Hereinafter, the final priority is referred to as “transmission priority”.

For example, in a case where a MAC PDU to be transmitted is already stored in a HARQ buffer, the terminal apparatus 10 determines the transmission priority on the basis of the highest LCH priority of LCH priorities corresponding to data segments of LCHs that are multiplexed in the MAC PDU, in accordance with the mapping restriction. In a case where a MAC PDU to be transmitted is not yet stored in a HARQ buffer, the terminal apparatus 10 determines the transmission priority on the basis of the highest LCH priority of LCH priorities corresponding to data segments of LCHs that can be multiplexed in the MAC PDU, in accordance with the mapping restriction. The transmission priority of an SR is an LCH priority of an LCH triggering the SR.

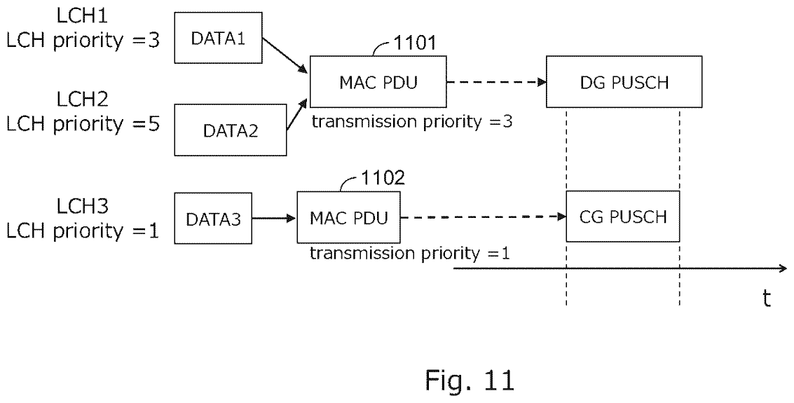

As illustrated in FIG. 11, in a case where data 1 corresponding to LCH 1 and data 2 corresponding to LCH 2 are multiplexed, the transmission priority of a MAC PDU 1101 including data 1 and data 2 is 3. The transmission priority of a MAC PDU 1102 including data 3 corresponding to LCH 3 is 1. In the example of FIG. 11, the MAC PDU 1101 corresponds to a DG-based uplink transmission (i.e., DG PUSCH). The DG PUSCH is, for example, a PUSCH and/or PUSCH transmission scheduled by using DCI (DCI format) that a CRC (CRC parity bit) scrambled with a C-RNTI and/or MCS-C-RNTI is added to. The MAC PDU 1102 corresponds to a CG-based uplink transmission (i.e., CG PUSCH). The CG PUSCH is, for example, a PUSCH and/or PUSCH transmission configured and/or indicated based on an information element included in an RRC message (for example, a “ConfiguredGrantConfig” IE). For example, the CG PUSCH may be activated and/or deactivated by using DCI that a CRC scrambled with a CS-RNTI is added to.

The terminal apparatus 10 compares the transmission priority of the MAC PDU 1101 and the transmission priority of the MAC PDU 1102. The transmission priority (=1) of the MAC PDU 1102 is higher than the transmission priority (=3) of the MAC PDU 1101. Thus, the terminal apparatus 10 may prioritize the CG PUSCH and cancel the DG PUSCH.

Hereinafter, an uplink grant prioritized based on transmission priorities as described above is referred to as “prioritized uplink grant”. In addition, an uplink grant not prioritized based on the transmission priorities as described above is referred to as “de-prioritized uplink grant”.

Here, “transmission prioritization/de-prioritization” may be determined based on “uplink grant prioritization/de-prioritization”. For example, “transmission prioritization” may be determined based on “prioritized uplink grant”. Furthermore, “transmission de-prioritization” may be determined based on “de-prioritized uplink grant”. For example, “MAC PDU transmission prioritization/de-prioritization” may be determined based on “uplink grant prioritization/de-prioritization”.

In the above, although a case is described that a CG-based uplink transmission and a DG-based uplink transmission have an overlap in a time resource, the terminal apparatus 10 may perform processing similar to processing described above also in a case where a plurality of CG-based uplink transmissions have an overlap in a time resource. Furthermore, the terminal apparatus 10 may perform processing similar to processing described above also in a case where a transmission of a PUCCH for an SR and a transmission of a UL-SCH have an overlap in a time resource.

Note that the transmission priority of an uplink-grant-based uplink transmission corresponding to a MAC PDU that data from an LCH is not multiplexed to may be lower than the transmission priority of an uplink-grant-based uplink transmission corresponding to the transmission priority of a MAC PDU that data from an LCH is multiplexed to or an SR triggered by the LCH.

In contrast, in a case where the transmission priorities are the same or “lch-BasedPrioritization” is absent in the “MAC-CellGroupConfig” IE, the terminal apparatus 10 may perform the first prioritization processing between uplink transmissions having an overlap in the time resource as below. In a case where a CG-based uplink transmission and a DG-based uplink transmission have an overlap in a time resource, the terminal apparatus 10 may prioritize the DG-based uplink transmission. In a case where a plurality of CG-based uplink transmissions have an overlap in a time resource, the terminal apparatus 10 may determine an uplink transmission to be prioritized, in accordance with implementation of the terminal apparatus 10. In a case where a transmission of a PUCCH for an SR and a transmission of a UL-SCH have an overlap in a time resource, the terminal apparatus 10 may prioritize the transmission of the UL-SCH.

The terminal apparatus 10 may perform the first prioritization processing in accordance with details described in Clause 5.4.1 of 3GPP TS 38.321 V 17.2.0 (2022-09). For example, regarding a CG, the terminal apparatus 10 may perform the first prioritization processing as below. In a case where “lch-BasedPrioritization” is present in the “MAC-CellGroupConfig” IE, regarding an uplink grant that is delivered to a HARQ entity and that a related PUSCH is transmittable by a lower layer, a MAC entity of the terminal apparatus 10 may determine whether all the following conditions (b1) to (b3) are satisfied.
(b1) In the same BWP, there is no overlapping PUSCH duration of another CG that is not yet de-prioritized and that has an LCH priority higher than that of the uplink grant.
(b2) In the same BWP, there is no overlapping PUSCH duration of an uplink grant that is not yet de-prioritized, that has an LCH priority higher than or equal to that of the uplink grant, and that is scrambled with a C-RNTI or scrambled with a CS-RNTI with NDI=1.
(b3) There is no overlapping PUSCH duration with an SR transmission that is not yet de-prioritized, that the simultaneous transmission of the SR and the uplink grant is not allowed, and that is triggered by an LCH having an LCH priority higher than that of the uplink grant.

The terminal apparatus 10 may consider a CG that satisfies the conditions (b1) to (b3) described above as a “prioritized uplink grant”. The terminal apparatus 10 may consider an uplink grant having an overlap with the CG as a “de-prioritized uplink grant”.

In another example, in a case where “lch-BasedPrioritization” is present in the “MAC-CellGroupConfig” IE and where a PUSCH transmission corresponding to a CG is cancelled by a cancellation indication RNTI (CI-RNTI) or cancelled by a PUCSH transmission having a high PHY priority, the terminal apparatus 10 may consider the CG as a “de-prioritized uplink grant”. Such cancellation of an uplink transmission by using a CI-RNTI is described later below.

### 1.8.2 PHY Layer Prioritization Processing

The terminal apparatus 10 may perform PHY layer prioritization processing (i.e., second prioritization processing) between uplink transmissions having an overlap in a time resource, based on PHY priorities.

Each PHY priority may be expressed in a value of either p0 or p1. In this configuration, the priority of p1 is higher than the priority of p0. The base station apparatus 20 transmits, to the terminal apparatus 10, information related to the PHY priority.

For example, in a case of a CG, the base station apparatus 20 may transmit, to the terminal apparatus 10, an RRC message including a PHY priority. The PHY priority may be included in an IE (for example, the “ConfiguredGrantConfig” IE) associated with the CG included in the RRC message.

In a case of an SR, the base station apparatus 20 may transmit, to the terminal apparatus 10, an RRC message including a PHY priority. The PHY priority may be included in an IE (for example, the “SchedulingRequestResourceConfig” IE) associated with the SR included in the RRC message.

Furthermore, for determination between an uplink transmission and UCI with respect to a downlink transmission, the base station apparatus 20 may transmit, to the terminal apparatus 10, a DCI format including a PHY priority. Specifically, the PHY priority may be included in the DCI format having scheduled the uplink transmission.

In a case where a plurality of uplink transmissions having an overlap in a time resource are scheduled, the terminal apparatus 10 may prioritize an uplink transmission with a high PHY priority (i.e., p1) and cancel an uplink transmission with a low PHY priority (i.e., p0).

In a case where uplink transmissions having the same PHY priority have an overlap in a time resource, the terminal apparatus 10 may perform the second prioritization processing as below. For example, in a case where a CG-based uplink transmission and a DG-based uplink transmission have an overlap in a time resource, the terminal apparatus 10 may prioritize the DG-based uplink transmission. In a case where a transmission of a PUCCH and a transmission of a PUSCH have an overlap in a time resource, the terminal apparatus 10 may multiplex the PUCCH to the PUSCH.

### 1.9. Inter-UE Prioritization Processing

In a case where a plurality of uplink transmissions by different terminal apparatuses 10 have an overlap in a time resource, the base station apparatus 20 may stop (or cancel) an uplink transmission by a terminal apparatus 10 with a low priority. Such processing is referred to as inter-UE prioritization processing.

The base station apparatus 20 transmits, to the terminal apparatus 10, DCI format 2_4 scrambled with a CI-RNTI. This enables the base station apparatus 20 to indicate cancellation of the uplink transmission by the terminal apparatus 10 with the low priority.

### 1.10. Autonomous Uplink Transmission Processing

In a case where an uplink grant is a CG and the uplink grant is considered to be de-prioritized in the intra-UE prioritization processing, the terminal apparatus 10 may perform autonomous uplink transmission processing.

The base station apparatus 20 may transmit, to the terminal apparatus 10, a configuration for activating the autonomous uplink transmission processing. For example, the configuration may be included in an IE associated with a CG included in an RRC message. The configuration may be “autonomousTx” included in the “ConfiguredGrantConfig” IE.

For example, the base station apparatus 20 transmits, to the terminal apparatus 10, an RRC message including “autonomousTx”. In a case where an uplink grant considered to be de-prioritized in the intra-UE prioritization processing is a CG configured with “autonomousTx”, the terminal apparatus 10 performs the autonomous uplink transmission processing.

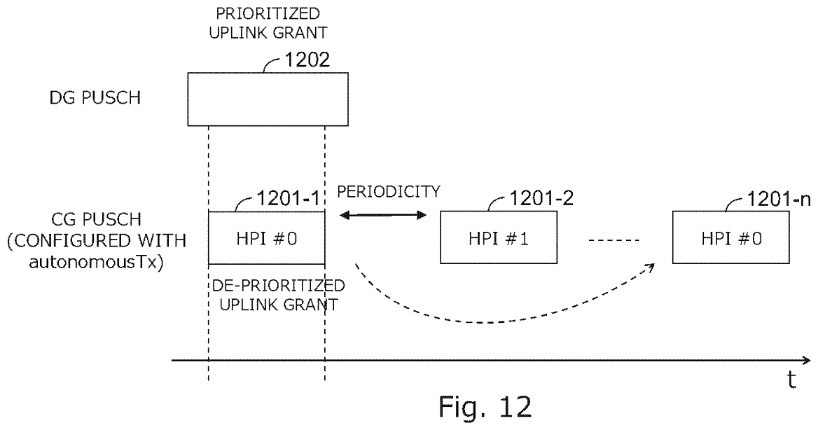

As illustrated in FIG. 12, a plurality of resources (i.e., a plurality of transmission occasions) 1201-1, 1201-2, . . . , 1201-n for a CG-based uplink transmission (i.e., CG PUSCH) are scheduled. Furthermore, a resource 1202 for a DG-based uplink transmission (i.e., DG PUSCH) is scheduled.

Here, the resource 1201-1 for the CG PUSCH and the resource 1202 for the DG PUSCH are assumed to have an overlap in a time resource. The terminal apparatus 10 considers an uplink grant corresponding to the CG PUSCH using the resource 1201-1 as a “de-prioritized uplink grant” in the intra-UE prioritization processing. Furthermore, the uplink grant is a CG configured with “autonomousTx”. Note that an HPI associated with the CG PUSCH using the resource 1201-1 is #0.

The terminal apparatus 10 prioritizes the DG PUSCH using the resource 1202 and cancels the CG PUSCH using the resource 1201-1. Then, the terminal apparatus 10 performs autonomous transmission processing of a MAC PDU corresponding to the cancelled CG PUSCH. As a new uplink transmission, the terminal apparatus 10 transmits the MAC PDU corresponding to the cancelled CG PUSCH, using the next resource (i.e., CG resource) 1201-n associated with an HPI (=#0) the same as the HPI associated with the cancelled CG PUSCH. In other words, in a case where, in CGs configured with “autonomousTx”, a previous CG in the HARQ process is not prioritized and no PUSCH transmission for a MAC PDU acquired is performed, a HARQ entity may consider the MAC PDU to have been acquired.

Note that, in the above-described case, “configuredGrantTimer” and “cg-RetransmissionTimer” associated with the HARQ process of the uplink grant considered to be de-prioritized are stopped, if they are running.

### 1.11. Extended Reality (eXtended Reality, XR)

Characteristics of traffic generated in XR will be described. In XR, a plurality of types of data (video data, voice data, user data, control data, and the like) are transmitted and received in parallel. A plurality of data streams corresponding to the data segments have different traffic characteristics and quality of service (QoS) requirements.

At timings of transmission and reception of the data, time shifts expressed as jitter, variability, and fluctuation may occur due to factors such as encoding of a video and audio and network latency.

Reference Literature 1 describes that the following definitions can be introduced for transmission and reception in XR.

[Reference Literature 1] 3GPP TR 23.700-60 V1.1.0 (2022-09)

PDU set: a set of PDUs including one or more PDUs carrying a payload of one unit of information generated at an application level. The application level corresponds, for example, to a frame or a video slice in an XR service.

Data burst: a set of datamultiple PDUs generated and sent by an application in a short period of time.

Furthermore, for XR, requirements of a packet delay budget (PDB) as the QoS requirements have been studied. The PDB is an upper bound of packet delay time allowed between the terminal apparatus 10 and the UPF. Note that Reference Literature 1 also describes that the following new QoS parameters can be introduced.

PDU-set delay budget (PSDB): an upper bound of PDU-set delay time allowed between the terminal apparatus 10 and the UPF.

PDU-set error rate (PSER): an upper bound of an error rate calculated between a PDU set processed by a sender, and all the PDUs in a PDU set that has not successfully delivered to an upper layer of a corresponding receiver.

### 1.12. Delay Information Report

### 1.12.1. Basic Configuration of Delay Information Report

For XR, implementation under various requirements including a requirement of low latency is assumed. With this, regarding uplink communication from a terminal apparatus, a base station is required to allocate radio resources taking account of the requirements. In order for such radio resource allocation to be performed, the terminal apparatus 10 transmits, to the base station apparatus 20, a delay information report including delay information for certain data. Note that the delay information report may be referred to as “delay status report”.

The certain data means a unit of data to be reported in the delay information report. Hereinafter, the certain data may be referred to as “data to be reported” or “unit of data to be reported”. Such a configuration allows the terminal apparatus 10 to transmit, to the base station apparatus 20, delay information regarding data to be reported.

The unit of data to be reported may be data corresponding to one LCG. Such one LCG may include one or a plurality of LCHs (i.e., data corresponding to one or a plurality of LCHs). In this configuration, the unit of data to be reported may be a part or all of the data available for one LCG. Note that the unit of data to be reported may be data corresponding to one LCH. The unit of data to be reported may be a part or all of the data available for one LCH.

The unit of data to be reported may be data corresponding to one PDU. In this configuration, the unit of data to be reported may be a part or all of the data available for one PDU. The unit of data to be reported may be data corresponding to one PDU set. In this configuration, the unit of data to be reported may be a part or all of the data available for one PDU set. Furthermore, the unit of data to be reported may be data corresponding to a plurality of PDU sets. For example, the unit of data to be reported may be data (or a part of data) available for one or a plurality of or all PDUs (or PDU sets) belonging to one PDU set.

The unit of data to be reported may be data corresponding to one data burst. In this configuration, the unit of data to be reported may be a part or all of the data available for one data burst. Note that the unit of data to be reported may be data corresponding to a plurality of data bursts. For example, the unit of data to be reported may be data (or a part of data) available for one or a plurality of or all data segments (or data bursts) belonging to one data burst.

The delay information may include one or both of information explicitly indicating delay and information implicitly indicating delay.

### Information Explicitly Indicating Delay

For example, the delay information may be a delay time or an index indicating the delay time. The delay information may be a remaining time until a certain first time limit is reached. The remaining time may be a time limit calculated based on a certain timer. For example, the certain timer may be “PDCP discard timer”. In this configuration, the delay information may be the remaining time calculated based on “PDCP discard timer”. The terminal apparatus 10 may calculate the remaining time based on “PDCP discard timer”, at a time of initial transmission of the delay information report. The delay information may include information related to a plurality of remaining times. In another example, the delay information may be information related to the shortest remaining time of a plurality of remaining times.

### Information Implicitly Indicating Delay

For example, the delay information may include information related to data provided with a temporal restriction or requirement among the data to be reported. Hereinafter, all the data to be reported is referred to as “first data” and the data provided with the temporal restriction or requirement among the data to be reported is referred to as “second data”. The delay information may be information related to a size of the second data. For example, the delay information may be an index indicating the number of bytes of the second data.

The second data may be data to be transmitted prioritized. The second data may be referred to as urgent data. The second data may be data that satisfies a condition related to delay. For example, the second data may be data configured with the first time limit. The second data may be data of which the remaining time is equal to or shorter than a certain first threshold Th1. The base station apparatus 20 may transmit, to the terminal apparatus 10, an RRC message including information indicating the first threshold Th1. The first threshold Th1 may be configured for an LCH. For example, the first threshold Th1 may be configured as a new element of the IE “LogicalChannelConfig”. The first threshold Th1 may be configured for an LCG. For example, the first threshold Th1 may be configured as a new element of the IE “logicalChannelGroup”. The first threshold Th1 may be configured for a PDU or PDU set. The first threshold Th1 may be configured for an IE related to the PDU or PDU set included in the RRC message. The first threshold Th1 may be configured for a data burst. The first threshold Th1 may be configured for an IE related to the data burst included in the RRC message. Note that the base station apparatus 20 may transmit, to the terminal apparatus 10, system information (SI, for example, SIB1 and/or SIB other than SIB1) including information indicating the first threshold Th1. The base station apparatus 20 may transmit, to the terminal apparatus 10, DCI including information indicating the first threshold Th1.

In another example, the second data may be data provided with a restriction or requirement related to a time shift in delay such as jitter. In still another example, the second data may be data provided with a restriction or requirement for a transmission rate.

Based on a size of the second data, the base station apparatus 20 can determine a degree of delay. In a case where the second data has a size larger than a certain size, the base station apparatus 20 may determine there is delay in transmission by the terminal apparatus 10. In a case where the second data has a size of the certain size or smaller, the base station apparatus 20 may determine there is no delay in transmission by the terminal apparatus 10.

### 1.12.2. Detailed Configuration of Delay Information Report

The terminal apparatus 10 may transmit, as the delay information report, a MAC CE including the delay information. For example, the terminal apparatus 10 may transmit a BSR including the delay information report. In this configuration, the terminal apparatus 10 may transmit the BSR including the delay information report in accordance with the following procedure.

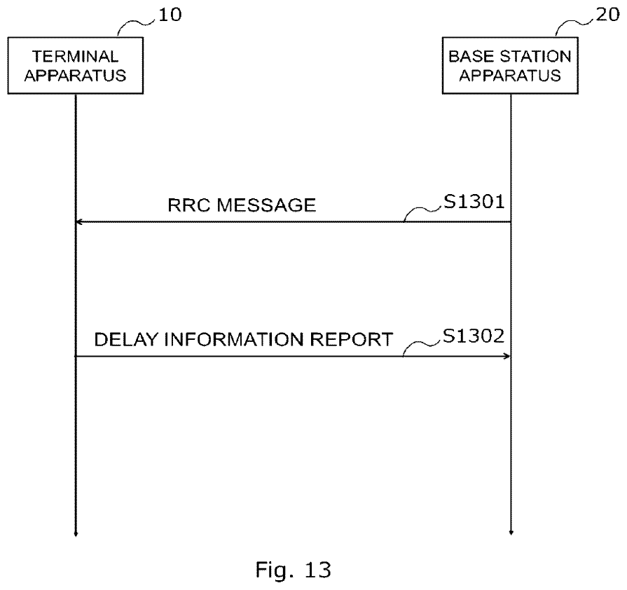

As illustrated in FIG. 13, the communicator 220 in the base station apparatus 20 transmits, to the terminal apparatus 10, an RRC message (S1301). The RRC message includes a parameter related to a BSR. The RRC message may be an RRC reconfiguration (RRCReconfiguration) message. Based on the parameter included in the RRC message, the controller 110 in the terminal apparatus 10 generates a BSR. The BSR includes buffer size information related to a buffer size and delay information. The communicator 120 in the terminal apparatus 10 transmits the BSR including the delay information report (S1302). The controller 210 in the base station apparatus 20 performs radio resource allocation for the terminal apparatus 10 based on the delay information report.

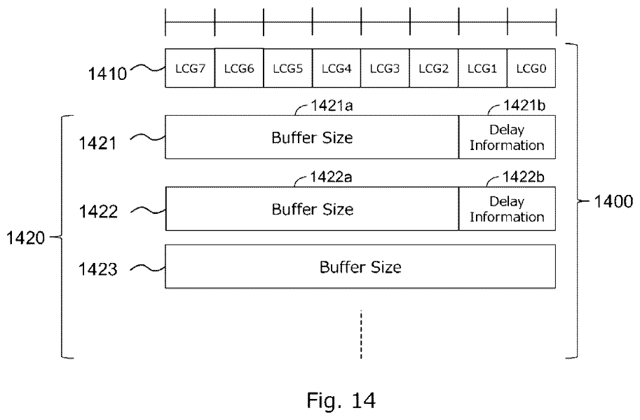

The terminal apparatus 10 may transmit Long BSR 1400 illustrated in FIG. 14. The Long BSR 1400 includes a first field 1410 and a second field 1420.

The first field 1410 may have a configuration the same as that of the LCG field 1010 in FIG. 10. The first field 1410 may be a field indicating whether LCGi has available data. For example, in a case where, in the first field 1410, the value of LCGi is 1, this may indicate that LCGi has available data. In a case where the value of LCGi is 0, this may indicate that LCGi has no available data.

In the present example, the second field 1420 includes three fields 1421 to 1423.

The field 1421 is a field related to LCG 1. The field 1421 includes a first part 1421a and a second part 1421b. In the present example, the first part 1421a has 6 bits and the second part 1421b has 2 bits. Note that, not limited to this configuration, the first part 1421a and the second part 1421b may each include the number of bits different from that in this example.

The first part 1421a indicates a buffer size related to data corresponding to LCG 1. For example, the first part 1421a may be an index indicating the number of bytes. The controller 110 may reference to a first buffer size table for 6 bits, in order to configure an index for the first part 1421a. The first buffer size table is a table that defines a correspondence relationship between buffer sizes and indices.

The second part 1421b indicates the delay information (e.g., the above-mentioned remaining time) related to the data corresponding to LCG 1. The second part 1421b may be an index indicating the delay information. The controller 110 may reference to a delay information table for 2 bits, in order to configure an index for the second part 1421b. The delay information table is a table that defines a correspondence relationship between delay information and indices.

The field 1422 is a field related to LCG 2. The field 1422 includes a first part 1422a and a second part 1422b. The first part 1422a and second part 1422b have a configuration the same as that of the first part 1421a and second part 1421b described above.

The field 1423 is a field related to LCG 3. The field 1423 indicates a buffer size related to data corresponding to LCG 3. Regarding the data corresponding to LCG 3, it is assumed that the remaining time is longer than the first threshold Th1. In other words, the data corresponding to LCG 3 has no delay. In this case, the field 1423 may include the information related to the buffer size and include no delay information. The controller 110 may reference to a second buffer size table for 8 bits, in order to configure an index for the field 1423. The second buffer size table is a table that defines a correspondence relationship between buffer sizes and indices. As described above, in order to configure an index corresponding to the information related to the buffer size, the controller 110 may switch a table for use between the first buffer size table and the second buffer size table.

Note that, in the example described above, although the second field 1420 includes the three fields 1421 to 1423, the configuration is not limited to this. The number of fields included in the second field 1420 may be variable. In another example, the order of fields included in the second field 1420 may be determined based on their LCH priorities.

In another example, the Long BSR 1400 may include a third field indicating whether the delay information is included for each LCG. For example, in the third field, a case where the value of LCGi is 1 may indicate that the delay information related to LCGi is included. A case where the value of LCGi is 0 may indicate that no delay information related to LCGi is included.

In still another example, the first part 1421a of the field 1421 and the first part 1422a of the field 1422 may each be information related to a size of the second data. The second data may be data of which the remaining time is equal to or less than the first threshold Th1. For example, the first part 1421a of the field 1421 may be information related to the size of the second data corresponding to LCG 1. Similarly, the first part 1422a of the field 1422 may be information related to the size of the second data corresponding to LCG 2.

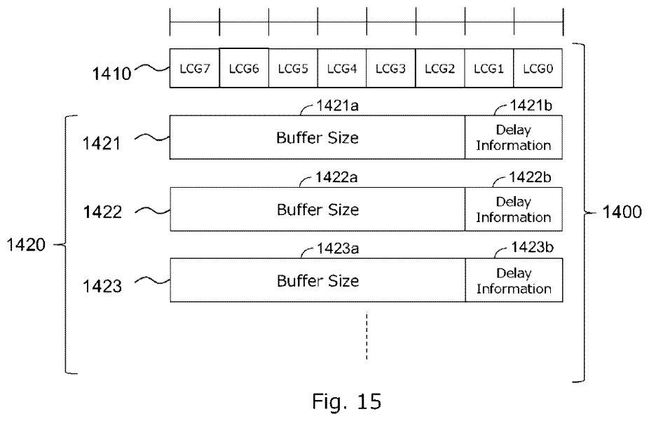

As illustrated in FIG. 15, each of the fields 1421 to 1423 included in the second field 1420 may include a first part corresponding to the information related to the buffer size and a second part corresponding to the delay information. Hereinafter, only details different from that of the configuration in FIG. 14 are described, and description on details the same as that of the configuration in FIG. 14 is omitted.

The field 1423 is a field related to LCG 3. The field 1423 includes a first part 1423a and a second part 1423b. In the present example, the first part 1423a has 6 bits and the second part 1423b has 2 bits. For example, the first part 1423a may be an index indicating the number of bytes. The controller 110 may reference to the first buffer size table, in order to configure an index for the first part 1423a. As described above, regarding the data corresponding to LCG 3, it is assumed that the remaining time is longer than the first threshold Th1. In this case, the second part 1423b may be blank. In another example, the second part 1423b may be a value (or index) indicating that no delay information is reported.

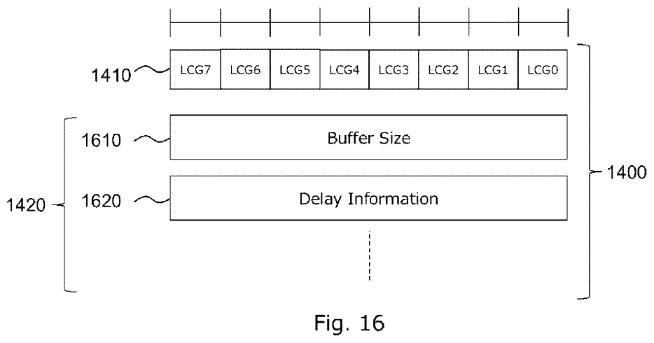

Furthermore, the configuration of the second field 1420 is not limited to the examples described above. As illustrated in FIG. 16, the second field 1420 may include a field 1610 of 8 bits corresponding to the information related to the buffer size and a field 1620 of 8 bits corresponding to the delay information. For example, the field 1610 indicates the information related to the buffer size of the data corresponding to LCG 1 and the field 1620 indicates the delay information related to the data corresponding to LCG 1. As described above, such buffer size information and delay information related to one LCG may be indicated with two different fields.

In the examples described above, although a configuration of Long BSR is described, the configuration is not limited to the examples. The configuration described above may be applied to Short BSR. For example, the terminal apparatus 10 may transmit Short BSR including the delay information.

Note that, although a configuration of a BSR including the delay information report is described, the configuration is not limited to this. A new MAC CE for transmission of the delay information may be defined. For example, the terminal apparatus 10 may transmit, as the delay information report, a MAC CE including the delay information. Thus, the term “BSR including delay information” described in the Specification may be replaced with “MAC CE including the delay information”.

The terminal apparatus 10 may receive, from the base station apparatus 20, first configuration information related to the delay information report. The base station apparatus 20 may transmit, to the terminal apparatus 10, an RRC message including the first configuration information. The base station apparatus 20 may transmit, to the terminal apparatus 10, system information (SI, for example, SIB1 and/or SIB other than SIB1) including the first configuration information. The base station apparatus 20 may transmit, to the terminal apparatus 10, DCI including the first configuration information.

The first configuration information may be “information indicating whether to transmit the delay information”. The first configuration information may indicate “transmission of the delay information” or “no transmission of the delay information”. The first configuration information may be a flag indicating “transmission of the delay information” or “no transmission of the delay information”. The first configuration information may be “information indicating whether to transmit the remaining time”. In addition, the first configuration information may be “information indicating whether to transmit information related to the size of the second data”.

For example, in a case where the RRC message includes the first configuration information, the terminal apparatus 10 may transmit the delay information report. In a case where the RRC message does not include the first configuration information, the terminal apparatus 10 may transmit no delay information report.

The first configuration information may be configured for an LCH. The terminal apparatus 10 may determine whether to include the delay information related to an LCH in a BSR, based on the first configuration information configured for the LCH. For example, in a case where the first configuration information indicates transmission of the delay information for a certain LCH, the terminal apparatus 10 may include the delay information related to the LCH in a BSR. For example, the first configuration information may be configured as a new element of the IE “LogicalChannelConfig”. The first configuration information may be configured for an LCG. The terminal apparatus 10 may determine whether to include the delay information related to an LCG in a BSR, based on the first configuration information configured for the LCG. For example, in a case where the first configuration information indicates transmission of the delay information for a certain LCG, the terminal apparatus 10 may include the delay information related to the LCG in a BSR. For example, the first configuration information may be configured as a new element of the IE “logicalChannelGroup”. The first configuration information may be configured for a PDU or PDU set. The terminal apparatus 10 may determine whether to include the delay information related to a PDU or PDU set in a BSR, based on the first configuration information configured for the PDU or PDU set. For example, in a case where the first configuration information indicates transmission of the delay information for a certain PDU or PDU set, the terminal apparatus 10 may include the delay information related to the PDU or PDU set in a BSR. The first configuration information may be configured for an IE related to the PDU or PDU set included in the RRC message. The first configuration information may be configured for a data burst. The terminal apparatus 10 may determine whether to include the delay information related to a data burst in a BSR, based on the first configuration information configured for the data burst. For example, in a case where the first configuration information indicates transmission of the delay information for a certain data burst, the terminal apparatus 10 may include the delay information related to the data burst in a BSR. The first configuration information may be configured for an IE related to the data burst included in the RRC message.

The terminal apparatus 10 may receive, from the base station apparatus 20, second configuration information related to the delay information report. The base station apparatus 20 may transmit, to the terminal apparatus 10, an RRC message including the second configuration information. The base station apparatus 20 may transmit, to the terminal apparatus 10, system information (SI, for example, SIB1 and/or SIB other than SIB1) including the second configuration information. The base station apparatus 20 may transmit, to the terminal apparatus 10, DCI including the second configuration information.

The second configuration information may indicate the type of the data to be reported. In this configuration, the terminal apparatus 10 selects the type of the data to be reported on the basis of the second configuration information. Regarding the selected data, the terminal apparatus 10 may transmit the delay information report.

The second configuration information may be explicit information indicating the type of the data to be reported or implicit information indicating the type of the data to be reported. An example of the explicit information and an example of the implicit information are described below.

### Explicit Information

The second configuration information may be information indicating any one of LCH, LCG, PDU, PDU set, and data burst.

### Implicit Information

The second configuration information may be the first configuration information. In this configuration, the terminal apparatus 10 may select the type of the data to be reported in accordance with an IE configured with the first configuration information.

In a case where the first configuration information is configured for a MAC cell group, this may indicate that the unit of data to be reported is data corresponding to one LCG. For example, the first configuration information may be configured for an IE related to the MAC cell group included in the RRC message. Examples of such an IE includes the IE “BSR-config”. As another example, in a case where the first configuration information is configured for an LCG, this may indicate that the unit of data to be reported is data corresponding to one LCG. For example, the first configuration information may be configured for an IE related to an LCG. Examples of such an IE includes the IE “logicalChannelGroup”.

In a case where the first configuration information is configured for a PDU or PDU set, this may indicate that the unit of data to be reported is data corresponding to a PDU or one or more PDU sets. For example, the first configuration information may be configured for an IE related to the PDU or PDU set included in the RRC message.

In a case where the first configuration information is configured for a data burst, this may indicate that the unit of data to be reported is data corresponding to one or more data bursts. For example, the first configuration information may be configured for an IE related to the data burst included in the RRC message.

For example, in a case where the RRC message includes information indicating the first threshold Th1, the terminal apparatus 10 may perform control to trigger (and/or transmit) the delay information report. In other words, in the case where the RRC message includes the information indicating the first threshold Th1, the terminal apparatus 10 may include, in a BSR, the delay information report, on the basis of the first threshold Th1. In a case where the RRC message does not include the information indicating the first threshold Th1, the terminal apparatus 10 may perform control not to trigger (and/or not to transmit) the delay information report. In other words, in the case where the RRC message does not include the information indicating the first threshold Th1, the terminal apparatus 10 may include no delay information report in a BSR.

A MAC PDU may include identification information for identification of whether the delay information report is provided. For example, a MAC subheader includes a value (i.e., codepoint) of LCID or eLCID. A value of LCID or eLCID for indication of the delay information report may be defined. Based on the type of the data to be reported, the following value of LCID or eLCID may be defined.
The MAC CE includes the delay information report and the unit of data to be reported is data corresponding to one LCH.
The MAC CE includes the delay information report and the unit of data to be reported is data corresponding to one LCG.
The MAC CE includes the delay information report and the unit of data to be reported is data corresponding to one PDU.
The MAC CE includes the delay information report and the unit of data to be reported is data corresponding to one or more PDU sets.
The MAC CE includes the delay information report and the unit of data to be reported is data corresponding to one or more data bursts.

In a case where a BSR includes the delay information report, based on the type of the data to be reported, the following value of LCID or eLCID may be defined.
The BSR includes the delay information report and the unit of data to be reported is data corresponding to one LCH.
The BSR includes the delay information report and the unit of data to be reported is data corresponding to one LCG.
The BSR includes the delay information report and the unit of data to be reported is data corresponding to one PDU.
The BSR includes the delay information report and the unit of data to be reported is data corresponding to one or more PDU sets.
The BSR includes the delay information report and the unit of data to be reported is data corresponding to one or more data bursts.

Furthermore, a value of LCID or eLCID may be defined indicating that the BSR includes the delay information report and that which one of the following formats the BSR is in.
Short BSR
Long BSR
Short Truncated BSR
Long Truncated BSR
Extended Short Truncated BSR
Extended Long Truncated BSR
Pre-emptive BSR
Extended Pre-emptive BSR

In another example, the MAC CE including the delay information report may include the identification information. For example, the BSR may further include a field including the identification information indicating that the delay information is included.

### 1.12.3. Condition to Trigger Delay Information Report

The terminal apparatus 10 may trigger the delay information report in accordance with a certain condition. Hereinafter, the condition is referred to as “trigger condition”. The trigger condition may include at least one of the conditions (a1) to (a4).

Furthermore, the trigger condition may include at least one of the following conditions (c1) to (c4).
(c1) There is data of which the remaining time is equal to or shorter than the first threshold Th1.
(c2) On-duration of discontinuous reception (DRX) is initiated.
(c3) There is a PDU set or data burst to be transmitted or the PDU set or data burst is buffered.
(c4) A PDU set is discarded.

### 1.13. Autonomous Transmission Processing of Delay Information Report

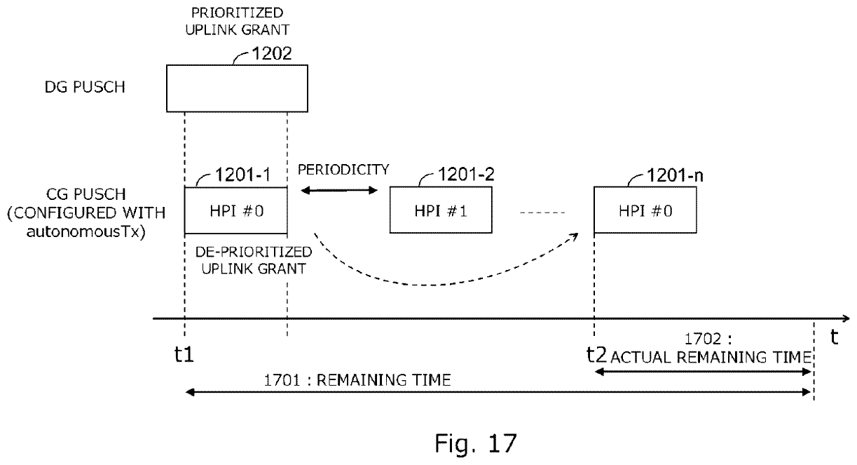

FIG. 17 illustrates a situation similar to that in FIG. 12. In FIG. 17, it is assumed that a MAC PDU corresponding to the CG PUSCH using the resource 1201-1 includes the delay information report. For example, the delay information included in the delay information report is the remaining time. The terminal apparatus 10 calculates a remaining time 1701, based on a time t1 of initial transmission.

The terminal apparatus 10 considers an uplink grant corresponding to the CG PUSCH using the resource 1201-1 as a “de-prioritized uplink grant” in the intra-UE prioritization processing. The terminal apparatus 10 cancels the CG PUSCH using the resource 1201-1. The uplink grant is a CG configured with “autonomousTx”. Thus, the terminal apparatus 10 performs autonomous transmission processing similarly to FIG. 12. As a new uplink transmission, the terminal apparatus 10 transmits the MAC PDU corresponding to the cancelled CG PUSCH, using the next resource 1201-n associated with the HPI (=#0) the same as that of the resource 1201-1.

However, an actual remaining time 1702 at a time t2 when the base station apparatus 20 receives the new uplink transmission is different from the remaining time 1701 calculated at the time t1. This may prevent the base station apparatus 20 from recognizing the accurate remaining time.

In order to solve such an issue described above, in a case where an uplink grant corresponding to an uplink transmission including the delay information report is considered as a “de-prioritized uplink grant” on the basis of the intra-UE prioritization processing, the terminal apparatus 10 may perform processing as below. Here, the uplink grant considered to be de-prioritized is a CG configured with autonomous transmission processing (i.e., a CG configured with “autonomousTx”).

The terminal apparatus 10 determines to perform an autonomous uplink transmission by using a second resource scheduled after a first resource that the uplink transmission described above is scheduled on. Note that the first resource may be referred to as “first CG resource” and the second resource may be referred to as “second CG resource”. The second resource may be a next resource associate with an HPI the same as that of the first resource. Then, the terminal apparatus 10 generates information (or data) for the autonomous uplink transmission.

At least part of a MAC PDU for the autonomous uplink transmission is different from a MAC PDU having not transmitted using the first resource. The terminal apparatus 10 may change at least part of the MAC PDU having not transmitted using the first resource to generate the MAC PDU for the autonomous uplink transmission.

For example, the information generated for the autonomous uplink transmission may be part or all of a MAC CE. The terminal apparatus 10 may change at least part of a MAC CE having not transmitted using the first resource to generate a MAC CE for the autonomous uplink transmission.

Note that a time (or period of time) of the first resource (i.e., first CG resource) may be expressed in one of or a combination of two or more of an SFN, a subframe, a slot, and a symbol (for example, first symbol location and/or last symbol location) for an uplink transmission (i.e., PUSCH transmission) corresponding to an uplink grant. A time (or period of time) of the second resource (i.e., second CG resource) may be referred to as “time (or period of time) for autonomous retransmission”. Similarly to the above, the time (or period of time) of the second resource may be expressed in one of or a combination of two or more of an SFN, a subframe, a slot, and a symbol (for example, first symbol location and/or last symbol location) for an uplink transmission (i.e., PUSCH transmission) corresponding to an uplink grant.

In the following, Aspect 1-1 to Aspect 1-3 that the information for the autonomous uplink transmission is generated are each described in detail.

Aspect 1-1

The controller 110 in the terminal apparatus 10 re-generates, as the information for the autonomous uplink transmission, the delay information report.

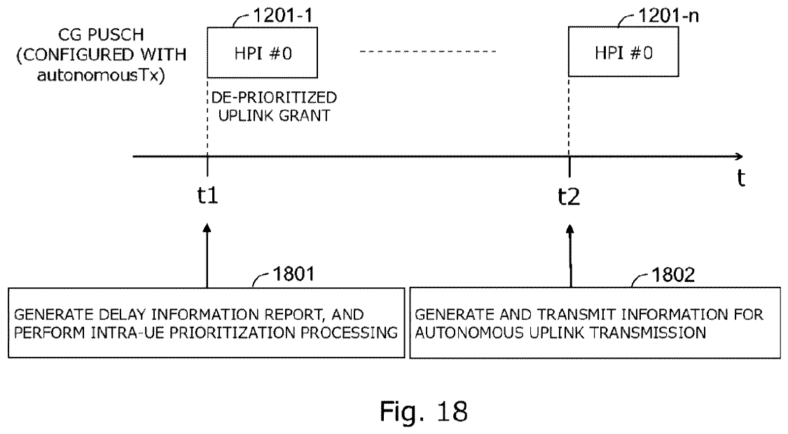

FIG. 18 illustrates a situation similar to that in FIG. 17. In the example of FIG. 18, the resource 1201-1 is referred to as “first resource 1201-1” and the resource 1201-n is referred to as “second resource 1201-n”.

The controller 110 in the terminal apparatus 10 calculates the remaining time using the time t1 of the first resource 1201-1 (i.e., time of first transmission) as a reference. For example, the remaining time may be a value calculated based on a certain timer (for example, “PDCP discard timer”), using the time t1 as a reference as described above. The controller 110 generates the delay information report including the remaining time. Furthermore, the controller 110 performs the intra-UE prioritization processing (1801). The controller 110 considers an uplink grant corresponding to the CG PUSCH using the first resource 1201-1 as a “de-prioritized uplink grant” in the intra-UE prioritization processing. The controller 110 determines to perform an autonomous uplink transmission by using the second resource 1201-n associated with an HPI the same as that of the first resource 1201-1.

Next, the controller 110 generates information for the autonomous uplink transmission. Specifically, the controller 110 re-calculates the remaining time using the time t2 of the second resource 1201-n as a reference. The controller 110 generates the delay information report including the re-calculated remaining time. The communicator 120 transmits the delay information report on the CG PUSCH using the second resource 1201-n (1802).

With the configuration described above, the terminal apparatus 10 can be prevented from transmitting the delay information report including inappropriate information (for example, remaining time). Specifically, the terminal apparatus 10 re-calculates the remaining time using the time t2 of the second resource 1201-n as a reference. This enables the terminal apparatus 10 to transmit the delay information report including accurate information.

Aspect 1-2

The processing of 1801 in FIG. 18 according to the present aspect is the same as that in Aspect 1-1. In the following, description is given only on the processing of 1802 different from that in Aspect 1-1.

The controller 110 generates, as the information for the autonomous uplink transmission, information including padding bits in a size the same as that of the delay information report. The communicator 120 transmits the generated information on the CG PUSCH using the second resource 1201-n (1802). In other words, the terminal apparatus 10 transmits the information including the padding bits in the size the same as that of the delay information report, without transmitting the information including the delay information report on the CG PUSCH using the second resource 1201-n.

With the configuration described above, the terminal apparatus 10 can be prevented from transmitting the delay information report including inappropriate information (for example, remaining time).

Aspect 1-3

The processing of 1801 in FIG. 18 according to the present aspect is the same as that in Aspect 1-1. In the following, description is given only on the processing of 1802 different from that in Aspect 1-1.

The controller 110 generates, as the information for the autonomous uplink transmission, information that the remaining time included in the delay information report is replaced with padding bits. The communicator 120 transmits the generated information on the CG PUSCH using the second resource 1201-n (1802).

With the configuration described above, the terminal apparatus 10 can be prevented from transmitting the delay information report including inappropriate information (for example, remaining time).

In another example, the controller 110 may generate a BSR as the information for the autonomous uplink transmission. In other words, the controller 110 may generate the BSR instead of the delay information report. The communicator 120 transmits the generated BSR on the CG PUSCH using the second resource 1201-n (1802). Note that the size of the BSR generated here may be the same as the size of the delay information report.

With the configuration described above, the terminal apparatus 10 can be prevented from transmitting the delay information report including inappropriate information (for example, remaining time). The terminal apparatus 10 generates the BSR instead of the delay information report. The terminal apparatus 10 can report a buffer status to the base station apparatus 20. The base station apparatus 20 can perform radio resource allocation by using the BSR.

### 2. Second Embodiment

Next, a configuration of a second embodiment will be described. In the following, part different from the first embodiment is only described, and description on part the same as the first embodiment is omitted. Hence, with respect to the configuration described in the present embodiment, the configuration of the first embodiment and any alteration thereof can be applied, as long as there is no inconsistency therebetween.

The terminal apparatus 10 applies the mapping restriction to the delay information report. The terminal apparatus 10 may transmit the delay information report, in accordance with the following procedure.

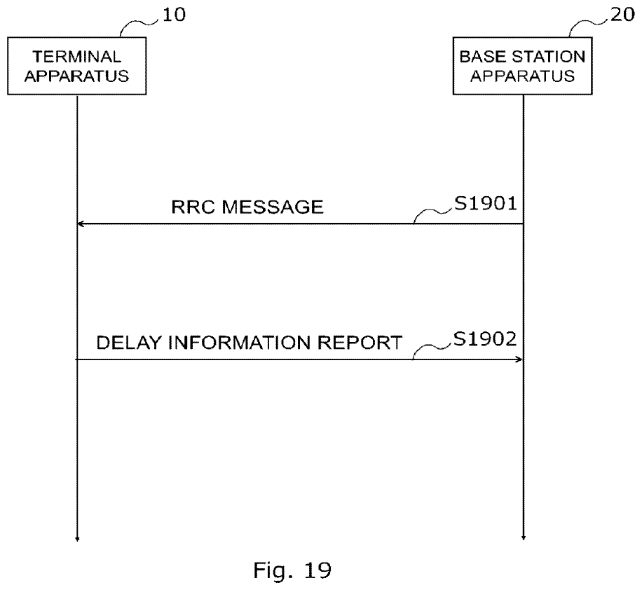

As illustrated in FIG. 19, the communicator 220 in the base station apparatus 20 transmits an RRC message to the terminal apparatus 10 (S1901). The RRC message includes third configuration information related to the mapping restriction for the delay information report. For example, the third configuration information may be configured for an IE associated with a MAC cell group included in the RRC message. Examples of such an IE may include the “MAC-CellGroupConfig” IE. The controller 110 in the terminal apparatus 10 generates the delay information report, based on the third configuration information included in the RRC message. Specifically, the controller 110 generates a MAC PDU including the delay information report, in accordance with the mapping restriction. The communicator 120 in the terminal apparatus 10 transmits the delay information report (S1902).

In the following, Aspect 2-1 to Aspect 2-3 of the third configuration information are each described in detail.

Aspect 2-1

The third configuration information may include information (for example, index) of a CG that mapping is allowed. The information of the CG may be a list or a sequence of CGs that mapping is allowed. In a case where the third configuration information is present, the delay information report may be mapped only to an indicated CG. In a case where the size of the sequence is zero, the delay information report may not be mapped to any CG. In a case where the third configuration information is absent, the delay information report may be mapped to any CG. For example, the information of the CG may be information indicating that the delay information report is mapped to a CG with a high transmission priority as compared with another uplink grant. With such a configuration, a possibility that an uplink grant corresponding to a CG PUSCH for transmission of the delay information report is considered as a “de-prioritized uplink grant” is lowered. In other words, a possibility that the autonomous uplink transmission processing is performed is lowered. This enables the terminal apparatus 10 to be prevented from transmitting the delay information report including inappropriate information (for example, remaining time).

In another example, the information of the CG may be information indicating that the delay information report is mapped to a CG with which autonomous uplink transmission processing is not configured (i.e., a CG not configured with “autonomousTx”). With such a configuration, no autonomous uplink transmission processing including the delay information report is performed. This enables the terminal apparatus 10 to be prevented from transmitting the delay information report including inappropriate information (for example, remaining time). In another example, the information of the CG may be information indicating that the delay information report is mapped to CG type 1.

Aspect 2-2

The third configuration information may include information (for example, PHY priority) of a DG that mapping is allowed. For example, the information of the DG may be information indicating that the delay information report is mapped to a DG with a certain PHY priority. In a case where the third configuration information is present and a DG has a PHY priority, the delay information report may be mapped only to a DG indicating a PHY priority equal to a configured value. In a case where the third configuration information is present and a DG has no PHY priority, the delay information report may be mapped the DG as long as the value p0 is configured. In a case where the third configuration information is absent, the delay information report may be mapped to any DG. For example, the information of the DG may be information indicating that the delay information report is mapped to a DG with a PHY priority being the value p1. With such a configuration, a possibility that an uplink grant corresponding to a DG PUSCH for transmission of the delay information report is considered as a “de-prioritized uplink grant” is lowered. This enables the terminal apparatus 10 to transmit the delay information report on the DG PUSCH.

Aspect 2-3

The third configuration information may include information of a PUSCH duration that mapping is allowed. The information of the PUSCH duration may be information related to a maximum PUSCH duration that the delay information report is mapped to. The maximum PUSCH duration may be a value selected from a plurality of values. In this configuration, the delay information report is mapped to a resource for an uplink grant with a PUSCH duration equal to or shorter than a value configured as the maximum PUSCH duration. For example, the shorter the maximum PUSCH duration, the lower the possibility that a plurality of uplink transmissions have an overlap in a time resource. In this case, no intra-UE prioritization processing is performed, and thus no autonomous uplink transmission processing including the delay information report is performed. In this, the terminal apparatus 10 can be prevented from transmitting the delay information report including inappropriate information (for example, remaining time). The terminal apparatus 10 can transmit the delay information report by using a resource corresponding to an uplink grant, without any intra-UE prioritization processing. In another example, the third configuration information may be a subcarrier spacing that mapping is allowed, a cell that mapping is allowed, and/or an uplink HARQ mode that mapping is allowed.

### 3. Third Embodiment

Next, a configuration of a third embodiment will be described. In the following, part different from the first embodiment and second embodiment is only described, and description on part the same as the first embodiment and second embodiment is omitted. Hence, with respect to the configuration described in the present embodiment, the configuration of the first embodiment and second embodiment and any alteration thereof can be applied, as long as there is no inconsistency therebetween.

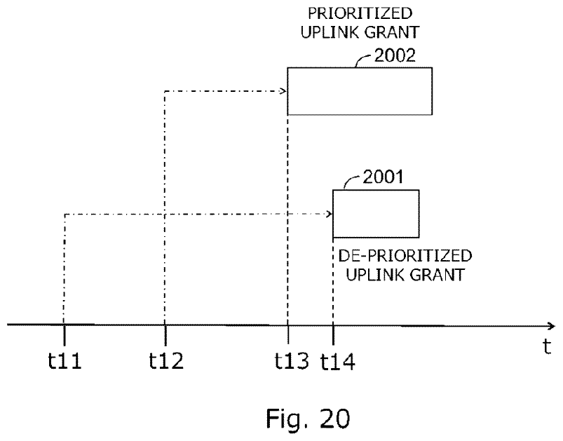

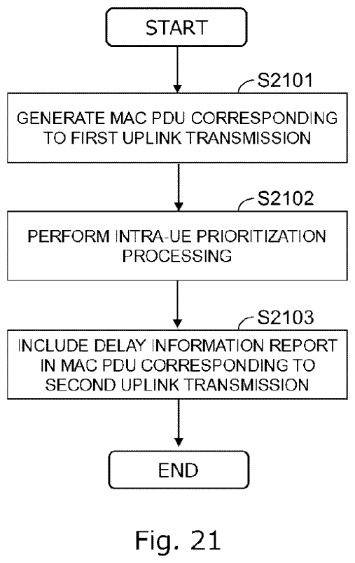

As illustrated in FIG. 20, the controller 110 in the terminal apparatus 10 triggers, at a time t11, the delay information report in accordance with the above-described trigger condition. An uplink transmission including the delay information report is referred to as “first uplink transmission”. An uplink grant corresponding to the first uplink transmission is referred to as “first uplink grant”. Note that the first uplink transmission is scheduled with a first resource 2001. As illustrated in FIG. 21, the controller 110 generates a MAC PDU corresponding to the first uplink transmission (S2101). The MAC PDU corresponding to the first uplink transmission includes the delay information report.

As illustrated in FIG. 20, at a time t12 later than the time t11, other uplink data occurs. An uplink transmission that the uplink data is transmitted is referred to as “second uplink transmission”. An uplink grant corresponding to the second uplink transmission is referred to as “second uplink grant”. Note that the second uplink transmission is scheduled with a second resource 2002.

The first resource 2001 and the second resource 2002 have an overlap in the time resource. As illustrated in FIG. 21, the controller 110 performs the intra-UE prioritization processing (S2102). The controller 110 considers the first uplink grant corresponding to the first uplink transmission as a “de-prioritized uplink grant” in the intra-UE prioritization processing. The controller 110 considers the second uplink grant corresponding to the second uplink transmission as a “prioritized uplink grant” in the intra-UE prioritization processing.

As illustrated in FIG. 21, the controller 110 generates a MAC PDU corresponding to the second uplink transmission. In this case, the controller 110 includes the delay information report in the MAC PDU corresponding to the second uplink transmission (S2103). The communicator 120 performs the second uplink transmission including the delay information report to the base station apparatus 20.

Note that, at a time point of S2103 in FIG. 21, the controller 110 need not cancel triggering of the delay information report yet. In a case where the second uplink transmission can be transmitted in a PHY layer, the controller 110 may cancel the triggering of the delay information report. In other words, at a time point when the controller 110 determines that an uplink transmission including the delay information report can be transmitted in a PHY layer, the controller 110 may cancel the triggering of the delay information report.

Alternatively, at a time point of S2101 in FIG. 21, the controller 110 may cancel the triggering of the delay information report. For example, in a case where a MAC PDU including the delay information report has been generated and/or transmitted, the controller 110 may cancel the triggering of the delay information report. In this case, on the basis of that the first uplink grant corresponding to an uplink transmission including the delay information report is considered as a de-prioritized uplink grant in S2102, the controller 110 may trigger the delay information report. Based on such triggering of the delay information report, the controller 110 includes the delay information report in the MAC PDU corresponding to the second uplink transmission (S2103).

In existing arts, in the situation of FIG. 20, the terminal apparatus 10 is not able to transmit the delay information report to the base station apparatus 20. In the present embodiment, even in a case where the first uplink transmission and second uplink transmission have an overlap in the time resource and where the first uplink grant corresponding to the first uplink transmission is considered as a “de-prioritized uplink grant”, the terminal apparatus 10 can include the delay information report in the second uplink transmission. With the configuration described above, the terminal apparatus 10 can transmit the delay information report more rapidly to the base station apparatus 20. In other words, as the situation in FIG. 20, even in a case where the first uplink transmission and second uplink transmission have an overlap in the time resource, delay in transmission of the delay information report can be suppressed to the minimum.

Note that the controller 110 may calculate the delay information (for example, remaining time) included in the delay information report, based on a time of first transmission of each uplink grant. For example, the remaining time may be a value calculated based on the certain timer (for example, “PDCP discard timer”), using the time of first transmission as a reference as described above. The controller 110 may calculate the delay information (for example, remaining time) included in a MAC PDU corresponding to the first uplink transmission, using a time t14 of the first resource 2001 that the first uplink transmission is scheduled on as a reference. The controller 110 may calculate the delay information (for example, remaining time) included in a MAC PDU corresponding to the second uplink transmission, using a time t13 of the second resource 2002 that the second uplink transmission is scheduled on as a reference. The time t13 is different from the time t14. Thus, the delay information (for example, remaining time) included in the MAC PDU corresponding to the first uplink transmission may be different from the delay information (for example, remaining time) included in the MAC PDU corresponding to the second uplink transmission.

In another example, the controller 110 may include, in the MAC PDU corresponding to the second uplink transmission, the delay information report included in the MAC PDU corresponding to the first uplink transmission. As described above, the controller 110 may include, in the second uplink transmission, the delay information report generated for the first uplink transmission. In this configuration, the delay information (for example, remaining time) included in the MAC PDU corresponding to the first uplink transmission is the same as the delay information (for example, remaining time) included in the MAC PDU corresponding to the second uplink transmission. For example, in a case where the time t13 is substantially the same as the time t14, there is substantially no difference in the delay information, and thus the controller 110 may perform such processing as described above.

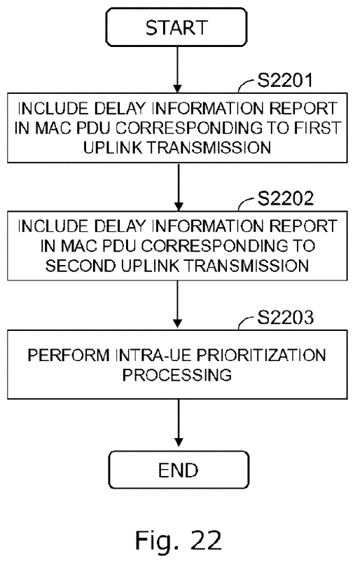

In the example of FIG. 21, after the first uplink grant is considered to be a “de-prioritized uplink grant” on the basis of the intra-UE prioritization processing, the controller 110 includes the delay information report in the MAC PDU corresponding to the second uplink transmission. The present embodiment is not limited to this. In a situation where the delay information report is triggered, when the first uplink transmission and second uplink transmission have an overlap in the time resource, the controller 110 may perform processing in a flow as in FIG. 22.

As illustrated in FIG. 22, the controller 110 generates a MAC PDU corresponding to the first uplink transmission. The controller 110 includes, in the MAC PDU, the delay information report (S2201). Next, the controller 110 generates a MAC PDU corresponding to the second uplink transmission. The controller 110 includes, in the MAC PDU, the delay information report (S2202). Then, the controller 110 performs the intra-UE prioritization processing (S2203).

With the configuration described above, the controller 110 includes, in both the MAC PDU corresponding to the first uplink transmission and the MAC PDU corresponding to the second uplink transmission, the delay information report before the intra-UE prioritization processing. This enables the terminal apparatus 10 to transmit the delay information report to the base station apparatus 20, regardless of whether the first uplink grant or second uplink grant is considered as a “prioritized uplink grant”.

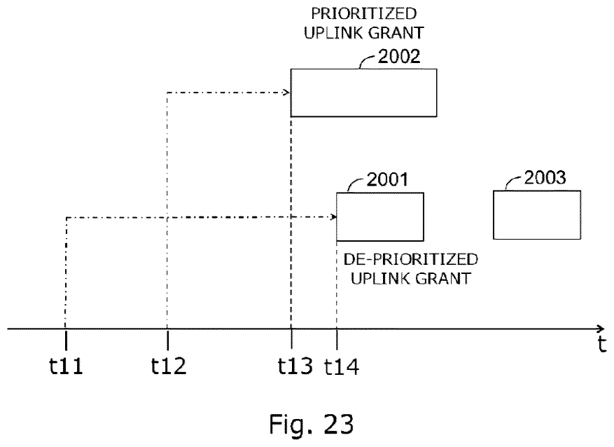

In the example described above, the controller 110 includes, in the second uplink transmission overlapping in the time resource with the first uplink transmission, the delay information report. The present embodiment is not limited to this. As illustrated in FIG. 23, the controller 110 may include, in an uplink transmission performed on a third resource 2003, the delay information report. The third resource 2003 is a resource that has no overlap in the time resource with the first resource 2001 and that is after the first resource 2001. The third resource 2003 may be a next resource associate with an HPI the same as that of the first resource 2001. The third resource 2003 may be a next resource associate with an HPI different from that of the first resource 2001.

Note that the terminal apparatus 10 may be configured to perform the processing described in FIGS. 20 to 23 in a case of transmitting a MAC CE including the delay information report and not to perform the processing in a case of transmitting a MAC CE including no delay information report.

### 4. Alterations

Although the present disclosure is described according to the embodiments, it is understood that the present disclosure is not limited to the embodiments or the structures. The present disclosure includes various alterations and variations within the equivalent scope. Any other combination including one or more elements included in the embodiments is included in the gist or spirit scope of the present disclosure.

Expressions such as words and phrases used in the embodiments are merely examples, and may be replaced with substantially the same or similar expressions. Particularly, since the technique according to the embodiments relates to technical specifications, the expressions in the embodiments may be replaced with substantially the same or similar expressions in the technical specifications (for example, the technical specifications cited in the Specification of the present application).

The information transmitted/received in the embodiments may be transmitted/received in the same or a different message or the same or a different element as or from that already described in the technical specifications, or may be transmitted/received in a new message or element to be defined. The information transmitted/received in the embodiments may be transmitted/received using a different layer and/or a different channel from that of the embodiments.

The means and/or the functions provided by the apparatuses described in the embodiments can be provided by software stored in a tangible memory apparatus and a computer that executes the software, the software only, hardware only, or a combination of those. For example, when one of the apparatuses is provided by an electronic circuit being hardware, it can be provided by a digital circuit including a number of logic circuits or an analog circuit.

The apparatuses described in the embodiments execute a program stored in a non-transitory tangible storage medium. Execution of the program causes execution of a method corresponding to the program.

### 5. Supplementary Notes

The whole or part of the embodiments and the alterations may be described as the following supplementary notes, but the disclosure is not limited to the contents of the following supplementary notes. The following expresses relationships in which a supplementary note that depends upon a plurality of supplementary notes depends upon a supplementary note that depends upon a plurality of supplementary notes. All of the dependency relationships of the supplementary notes expressed below are included in the embodiments.

### Supplementary Note 1

A Terminal Apparatus Including:
a controller configured to, in a case where a first uplink grant corresponding to a first uplink transmission including a delay information report including delay information is considered to be a de-prioritized uplink grant on a basis of prioritization processing, include the delay information report in a second uplink transmission corresponding to a second uplink grant different from the first uplink grant, and
   a communicator configured to perform the second uplink transmission to a base station apparatus.

### Supplementary Note 2

The terminal apparatus according to supplementary note 1, wherein
a first resource that the first uplink transmission is scheduled on and a second resource that the second uplink transmission is scheduled on have an overlap, and
the second uplink grant is an uplink grant considered to be a prioritized uplink grant on the basis of the prioritization processing.

### Supplementary Note 3

The terminal apparatus according to supplementary note 2, wherein
the controller is configured to
   calculate, using a time of the first resource as a reference, the delay information of the delay information report included in the first uplink transmission, and
   calculate, using a time of the second resource as a reference, the delay information of the delay information report included in the second uplink transmission.

### Supplementary Note 4

The terminal apparatus according to supplementary note 2, wherein
the controller is configured to include, in the second uplink transmission, the delay information report included in the first uplink transmission.

### Supplementary Note 5

The terminal apparatus according to supplementary note 2, wherein
the controller is configured to, after the first uplink grant is considered to be the de-prioritized uplink grant on the basis of the prioritization processing, include the delay information report in a medium access control protocol data unit (MAC PDU) corresponding to the second uplink transmission.

### Supplementary Note 6

The terminal apparatus according to supplementary note 2, wherein
the controller is configured to, before the prioritization processing, include the delay information report in a medium access control protocol data unit (MAC PDU) corresponding to the second uplink transmission.

### Supplementary Note 7

The terminal apparatus according to supplementary note 1, wherein
the second uplink transmission is an uplink transmission that has no overlap with a first resource where the first uplink transmission is scheduled on and that is performed on a second resource scheduled after the first resource.

### Supplementary Note 8

The terminal apparatus according to supplementary note 1, wherein
the controller is configured to, in a case where it is determined that the second uplink transmission is possible to be transmitted in a physical (PHY) layer, cancel triggering of the delay information report.

### Supplementary Note 9

The terminal apparatus according to any one of supplementary notes 1 to 8, wherein
the delay information includes information related to a remaining time calculated based on a certain timer.

### Supplementary Note 10

The terminal apparatus according to any one of supplementary notes 1 to 9, wherein
the delay information report is a buffer status report (BSR) including the delay information and buffer size information related to a buffer size.

### Supplementary Note 11

The terminal apparatus according to supplementary note 10, wherein
the BSR includes
   a field including the delay information and the buffer size information, and
   a field including the buffer size information and not including the delay information.

### Supplementary Note 12

The terminal apparatus according to any one of supplementary notes 1 to 11, wherein
the controller is configured to generate a medium access control protocol data unit (MAC PDU) including the delay information report, and
identification information for identification of the delay information report is included in a MAC CE or a header included in the MAC PDU.

### Supplementary Note 13

The terminal apparatus according to any one of supplementary notes 1 to 12, wherein
the delay information is delay information about certain data, and
the certain data is
   data corresponding to one logical channel,
   data corresponding to one logical channel group (LCG),
   data corresponding to one or more protocol data unit sets (PDU sets), or
   data corresponding to one or more data bursts.

### Supplementary Note 14

A method of a terminal apparatus, the method including:
including, in a case where a first uplink grant corresponding to a first uplink transmission including a delay information report including delay information is considered to be a de-prioritized uplink grant on a basis of prioritization processing, the delay information report in a second uplink transmission corresponding to a second uplink grant different from the first uplink grant; and
performing the second uplink transmission to a base station apparatus.

### Supplementary Note 15

A program causing a processor in a terminal apparatus to execute:
including, in a case where a first uplink grant corresponding to a first uplink transmission including a delay information report including delay information is considered to be a de-prioritized uplink grant on a basis of prioritization processing, the delay information report in a second uplink transmission corresponding to a second uplink grant different from the first uplink grant; and
performing the second uplink transmission to a base station apparatus.

### Supplementary Note 16)

A non-transitory tangible storage medium storing thereon a program causing a processor in a terminal apparatus to execute:
including, in a case where a first uplink grant corresponding to a first uplink transmission including a delay information report including delay information is considered to be a de-prioritized uplink grant on a basis of prioritization processing, the delay information report in a second uplink transmission corresponding to a second uplink grant different from the first uplink grant; and
performing the second uplink transmission to a base station apparatus.

The disclosure contents of the above-mentioned related art documents and reference literature are incorporated herein by reference.

What is claimed is:

1. A terminal apparatus comprising:
a receiver configured to receive, from a base station apparatus, a radio resource control (RRC) message including first information for configuring an identifier (ID) of a logical channel group (LCG) to which a logical channel (LCH) belongs; and
a controller, wherein
the controller is configured to:
trigger, based on a shortest remaining time of a discard timer for data becoming below a threshold for the LCG, a delay status report in a case where second information for indicating the threshold for the LCG is included in the RRC message, and
cancel the triggered delay status report in a case where a medium access control protocol data unit (MAC PDU) including a medium access control (MAC) control element (CE) of the delay status report that contains delay information is transmitted.

2. The terminal apparatus according to claim 1, wherein
the MAC CE of the delay status report includes
a first field indicating whether to include the delay information for the LCG,
a second field indicating a shortest remaining time of the discard timer for the data for the LCG at a time of a first transmission of the delay status report, and
a third field indicating a size of data for the LCG.

3. The terminal apparatus according to claim 2, wherein
the size of data for the LCG indicated in the third field is the size of data for the LCG for which a remaining time of the discard timer is less than the threshold for the LCG.

4. A method of a terminal apparatus, the method comprising:
receiving, from a base station apparatus, a radio resource control (RRC) message including first information for configuring an identifier (ID) of a logical channel group (LCG) to which a logical channel (LCH) belongs,
triggering, based on a shortest remaining time of a discard timer for data becoming below a threshold for the LCG, a delay status report in a case where second information for indicating the threshold for the LCG is included in the RRC message; and
canceling the triggered delay status report in a case where a medium access control protocol data unit (MAC PDU) including a medium access control (MAC) control element (CE) of the delay status report that contains delay information is transmitted.

5. The method according to claim 4, wherein
the MAC CE of the delay status report includes
a first field indicating whether to include the delay information for the LCG,
a second field indicating a shortest remaining time of the discard timer for the data for the LCG at a time of a first transmission of the delay status report, and
a third field indicating a size of data for the LCG.

6. The method according to claim 5, wherein
the size of data for the LCG indicated in the third field is the size of data for the LCG for which a remaining time of the discard timer is less than the threshold for the LCG.

7. A base station apparatus comprising:
a transmitter configured to transmit, to a terminal apparatus, a radio resource control (RRC) message including first information for configuring an identifier (ID) of a logical channel group (LCG) to which a logical channel (LCH) belongs; and
a receiver configured to receive, from the terminal apparatus, a delay status report in a case where the second information for indicating a threshold for the LCG is included in the RRC message, the delay status report being triggered based on a shortest remaining time of a discard timer for data becoming below the threshold for the LCG, wherein
the triggered delay status report is cancelled in a case where a medium access control protocol data unit (MAC PDU) including a medium access control (MAC) control element (CE) of the delay status report that contains delay information is transmitted from the terminal apparatus.

8. The base station apparatus according to claim 7, wherein
the MAC CE of the delay status report includes
a first field indicating whether to include the delay information for the LCG,
a second field indicating a shortest remaining time of the discard timer for the data for the LCG at a time of a first transmission of the delay status report, and
a third field indicating a size of data for the LCG.

9. The method according to claim 8, wherein
the size of data for the LCG indicated in the third field is the size of data for the LCG for which a remaining time of the discard timer is less than the threshold for the LCG.
